(19) United States
(12) Patent Application Publication
(10) Pub. No.: US 2026/0247270 A1
(43) Pub. Date: Aug. 20, 2026

(54) INFORMATION PROCESSING DEVICE, TERMINAL DEVICE, INFORMATION PROCESSING METHOD, AND BASE STATION

(71) Applicant: Sony Group Corporation, Tokyo (JP)

(72) Inventor: Shinichiro TSUDA, Tokyo (JP)

(73) Assignee: Sony Group Corporation, Tokyo (JP)

(21) Appl. No.: 19/160,472

(22) PCT Filed: Jun. 6, 2024
(86) PCT No.: PCT/JP2024/020619

§ 371 Date: Aug. 28, 2025

(30) Foreign Application Priority Data
Jun. 14, 2023 (JP) 2023-097979

(51) Int. Cl. H04W 48/18; H04W 28/02; H04W 60/04

(52) U.S. Cl. CPC H04W 48/18; H04W 28/0268; H04W 60/04

(57) ABSTRACT

An information processing device includes circuitry that is configured to acquire, from a home network, first quality information regarding one or more first communication qualities supported by a requestable slice whose use is requestable by a terminal device. The circuitry selects a support slice that supports a second communication quality corresponding to the first quality information among second network slices provided by a visitor network. The circuitry generates mapping information regarding a correspondence between a configured slice configured by the visitor network and including the selected support slice, and the requestable slice. The circuitry notifies the terminal device of configured slice information regarding the configured slice and the mapping information.

### TECHNICAL FIELD

The present disclosure relates to an information processing device, a terminal device, an information processing method, and a base station.

### BACKGROUND ART

The first standard of the 5th generation mobile communication system, so-called 5G, was formulated as Rel-15 in 2018, and a 5G-compatible service was started in Japan in March 2020. In addition, service provision in the form of local 5G in which an entity other than a telecommunication carrier provides the 5G service is also starting. The 5G has characteristics of high speed and large capacity (enhanced Mobile Broadband (eMBB)), low latency and high reliability (ultra-reliable and low latency communications (URLLC)), and multiple simultaneous connection (massive machine type communication (mMTC)).

Network slice selection assistance information is used to identify a network slice. A public wireless communication carrier can use non-standardized network slice selection assistance information uniquely configured in each public wireless communication carrier, in addition to standardized network slice selection assistance information.

For example, PTL 1 describes a technology for mapping network slice selection assistance information of a public wireless communication carrier for visitors as a registration destination and network slice selection assistance information of a public wireless communication carrier for a corresponding home when roaming. In PTL 1, by storing the mapped network slice selection assistance information in a terminal device, the terminal device can use the non-standardized network slice selection assistance information with the public wireless communication carrier for visitors.

### CITATION LIST

### Patent Literature

PTL 1: Japanese Laid-open Patent Publication No. 2021-166359

### SUMMARY OF INVENTION

### Technical Problem

In the future, it is assumed that new local communication carriers such as a private network and the local 5G increase in addition to conventional public wireless communication carriers for visitors as roaming candidates. At this time, it is expected that not only a form of a static roaming agreement but also a dynamic roaming agreement or the like is introduced.

Then, it is required to share information related to the mapping of the non-standardized network slice selection assistance information between a public wireless communication carrier for a home and a local communication carrier as a roaming destination. For this purpose, introduction of a mechanism for dynamically generating the mapping information is required.

Therefore, the present disclosure provides a mechanism for dynamically generating mapping information of a network slice.

It should be noted that the above-mentioned problem or purpose is only one of a plurality of problems or purposes that can be solved or achieved by a plurality of embodiments disclosed in the present specification.

### Solution to Problem

An information processing device of the present disclosure includes a control unit. The control unit acquires, from a home network, first quality information regarding one or more first communication qualities supported by a requestable slice whose use is requestable by a terminal device among first network slices provided by the home network. The control unit selects a support slice that supports a second communication quality corresponding to the first quality information among second network slices provided by a visitor network. The control unit generates mapping information regarding a correspondence between a configured slice configured by the visitor network and including the selected support slice, and the requestable slice. The control unit notifies the terminal device of configured slice information regarding the configured slice and the mapping information.

### BRIEF DESCRIPTION OF DRAWINGS

FIG. 1 is a diagram illustrating a configuration of a network architecture of a fifth generation (5G) system.

FIG. 2 is a block diagram illustrating an example of a configuration of an information processing device according to an embodiment of the present disclosure.

FIG. 3 is a diagram illustrating an example of a configuration of a base station according to an embodiment of the present disclosure.

FIG. 4 is a block diagram illustrating an example of a configuration of a terminal device according to an embodiment of the present disclosure.

FIG. 5 is a diagram illustrating an example of a configuration of a network architecture of the 5G system for roaming.

FIG. 6 is a table illustrating standardized SST values.

FIG. 7 is a diagram illustrating an example of a quality of service (QoS) architecture of the 5G system (5GS).

FIG. 8 is a flowchart illustrating an example of registration processing for a visitor network according to a first embodiment.

FIG. 9 is a sequence diagram illustrating an example of processing of requesting for update of configured network slice selection assistance information (NSSAI) for the visitor network according to the first embodiment.

FIG. 10 is a flowchart illustrating an example of a flow of generation processing for the configured NSSAI for the visitor network and first mapping information in a V-network slice selection function (NSSF) 304-2.

FIG. 11 is a flowchart illustrating an example of a flow of second S-NSSAI selection processing according to the first embodiment.

FIG. 12 is a flowchart illustrating an example of a flow of generation processing for the first mapping information according to the first embodiment.

FIG. 13 is a flowchart illustrating an example of a flow of mapping processing for second S-NSSAI according to the first embodiment.

FIG. 14 is a sequence diagram illustrating another example of the processing of requesting for update of the configured NSSAI for the visitor network according to the first embodiment.

FIG. 15 is a sequence diagram illustrating an example of registration/re-registration processing with respect to the visitor network accompanying the update of the configured NSSAI according to the first embodiment.

FIG. 16 is a sequence diagram illustrating an example of registration processing for complementing S-NSSAI of a home network with the visitor network.

FIG. 17 is a diagram illustrating an example of an architecture of a communication system according to a second embodiment.

FIG. 18 is a diagram illustrating another example of the architecture of the communication system according to the second embodiment.

FIG. 19 is a diagram illustrating an example of processing for complementing S-NSSAI of a home network with a visitor network according to the second embodiment.

### DESCRIPTION OF EMBODIMENTS

Hereinafter, embodiments of the present disclosure will be described in detail with reference to the appended drawings. Note that, in the present specification and the drawings, components having substantially the same functional configuration are provided with the same reference signs, so that an overlapping description of these components is omitted.

In addition, in the present specification and drawings, similar components of embodiments may be distinguished by adding at least one of different alphabets or different numerals after the same reference sign. However, in a case where it is not necessary to particularly distinguish each of similar components, only the same reference sign is assigned.

Each of one or more embodiments (including examples, modified examples, and application examples) described below can be implemented independently. On the other hand, at least some of the plurality of embodiments described below may be implemented in combination with at least some of other embodiments as appropriate. These plurality of embodiments may include novel characteristics different from each other. Therefore, these plurality of embodiments can contribute to achieve or solving different purposes or problems, and can exert different effects.

### 1. Overview of Proposed Technology

It is required to share information related to mapping of non-standardized network slice selection assistance information between a public wireless communication carrier for a home and a local communication carrier as a roaming destination. For this purpose, introduction of a mechanism for dynamically generating the mapping information is required.

Therefore, an information processing device according to the proposed technology of the present disclosure acquires first quality information from a home network. The home network is, for example, a home public land mobile network (HPLMN) of a terminal device, and is a network that provides a service to the terminal device.

The first quality information is information regarding one or more first communication qualities (for example, quality-of-service (QoS) identification information) supported by a requestable slice (for example, single network slice selection assistance information (S-NSSAI) included in information related to subscribed S-NSSAI) whose use is requestable by the terminal device among first network slices provided by the home network.

The information processing device is, for example, a device that implements a function of a network function (NF) in a communication system of a visitor network. The visitor network is, for example, a visitor PLMN (VPLMN) and is a roaming destination of the terminal device. When the HPLMN enters into a service level agreement (SLA) with the VPLMN, the terminal device can utilize a service of the VPLMN in the form of roaming.

The information processing device selects a support slice that supports a second communication quality corresponding to the first quality information among second network slices provided by the visitor network.

The information processing device generates mapping information regarding a correspondence between a configured slice (for example, configured NSSAI) configured by the visitor network and including the selected support slice, and the requestable slice. The information processing device notifies the terminal device of configured slice information regarding the configured slice and the mapping information.

As described above, the information processing device according to the present embodiment acquires, from the home network, information regarding a type of a fifth generation (5G) QoS identifier (5QI) supported by the network slice in the visitor network that dynamically supports roaming. As a result, the information processing device can dynamically map a non-standardized network slice used in the home network and the network slice used in the visitor network. As a result, the terminal device can receive a service of a communication quality similar to that of the home network even in the visitor network.

### 2. Example of Configuration of Communication System

### 2-1. Network Architecture of 5G System

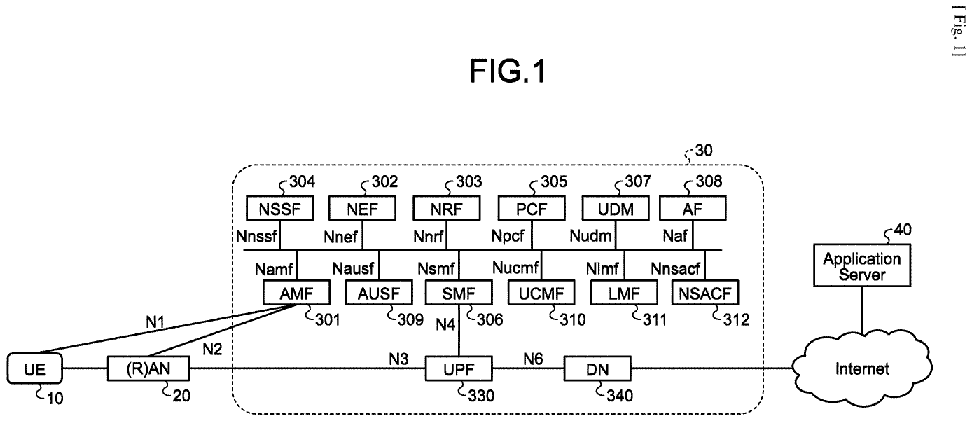

A communication system according to an embodiment of the present disclosure is, for example, a 5G system. Here, an example of a network architecture of the 5G system which is the communication system according to the present embodiment will be described with reference to FIG. 1.

FIG. 1 is a diagram illustrating a configuration of the network architecture of the 5G system. Hereinafter, the 5G system is abbreviated as 5GS.

The 5GS includes a user equipment (UE) 10, a (R)AN 20, and a 5G core (5GC) 30. Note that the 5GC is also referred to as NG core (NGC) or a core network. In addition, the notation of (R)AN represents a base station including a radio access network (RAN) and an access network (AN). Hereinafter, the (R)AN 20 is also referred to as a base station 20. In addition, the UE 10 is a terminal device. Hereinafter, the UE 10 is also referred to as a terminal device 10.

When an application server (AS) 40 that processes an application is connected to the 5GS via the Internet, the UE 10 can use the application via the 5G service.

In a case where an entity that provides the application, for example, a service provider, has an agreement such as a service level agreement (SLA) with a public land mobile network (PLMN) operator that provides the 5G service, the application server 40 is arranged in the 5GC 30 as a data network (DN) 340. Alternatively, the application server 40 can be connected to the DN 340 via a dedicated line or a virtual private network (VPN).

Note that the application server 40 is also referred to as a cloud server. Alternatively, the application server 40 may be provided in the form of an edge server.

A function group of a control plane of the 5GS includes an access and mobility management function (AMF) 301, a network exposure function (NEF) 302, and a network repository function (NRF) 303. The function group of the control plane further includes a network slice selection function (NSSF) 304, a policy control function (PCF) 305, a session management function (SMF) 306, and a unified data management (UDM) 307. The function group of the control plane includes an application function (AF) 308, an authentication server function (AUSF) 309, and a UE radio capability management function (UCMF) 310. The function group of the control plane includes a location management function (LMF) 311 and a network slice access control function (NSACF) 312. As described above, the control plane function group includes a plurality of network functions (NFs).

Here, the AF 308 may operate as an NF that processes a control plane of the application server 40. The AF 308 may be implemented in a physically identical device as an entity logically different from the application server 40, that is, the application server 40. In addition, the AF 308 may operate as an NF that processes the control plane of the 5GS for the application and may be arranged in the 5GC 30.

The service provider managing and operating the application server 40 can acquire information from each NF of the 5G system via the NEF 302 within a range of the service level agreement (SLA) with the PLMN operator. The NEF 302 can securely secure and disclose a capability and an event of each NF to the service provider.

The UDM 307 includes a unified data repository (UDR) that holds and manages contractor information, and a front end (FE) unit that processes the contractor information.

The AMF 301 performs mobility management. A detailed operation of the AMF 301 related to the present embodiment will be described later. The SMF 306 performs session management.

The PCF 305 provides a unified policy framework for governing a network operation and provides a policy rule for each network function of the control plane. In addition, the PCF 305 accesses the contractor information of the UDR for policy determination.

The UCMF 310 holds UE radio capability information corresponding to all UE radio capability IDs (UE RadioCapability IDs) in the PLMN. The UCMF 310 is responsible for assigning respective PLMN-assigned UE radio capability IDs.

The LMF 311 provides assistance data for positioning to the UE 10 in a UE-Based mode. The UE 10 can perform measurement and location calculation related to a global navigation satellite system (GNSS) by using the assistance data acquired from the LMF 311. The UE 10 can use, for example, a widely known technology called Assisted-GNSS.

In a UE-Assisted mode, the LMF 311 acquires a measured value related to the GNSS such as code phase, Doppler, and carrier phase from the UE 10 equipped with a GNSS receiver, and calculates the location of the UE 10.

For the UE 10 that is equipped with the GNSS receiver but cannot receive a signal from the GNSS, or for the UE 10 that is not equipped with the GNSS, the LMF 311 may acquire information regarding the location of the UE 10 by a positioning techniques called:
observed time difference of arrival (OTDOA)
multi-round trip time (RTT)
downlink angle-of-departure (DL AoD)
downlink time difference of arrival (DL TDOA)
uplink time difference of arrival (UL TDOA)
angle of arrival (UL AoA).

The NSACF 312 monitors and controls the number of UEs 10 registered for each network slice, the number of established protocol data unit (PDU) sessions, and the number of UEs 10 establishing one or more PDU sessions. As a result, the NSACF 312 applies admission control for preventing congestion in each network slice. In addition, the NSACF 312 supports notification and reporting of a status of the network slice according to an event for each NF.

One of requirements for the network slices is securing isolation between the network slices. In particular, in a case of supporting a plurality of network slices in a finite radio resource, the admission control is applied to prevent congestion in each network slice, so that other network slices are not affected.

The NSSF 304 will be described later.

Here, Namf is a service-based interface provided by the AMF 301. Nsmf is a service-based interface provided by the SMF 306. Nnef is a service-based interface provided by the NEF 302.

Npcf is a service-based interface provided by the PCF 305. Nudm is a service-based interface provided by the UDM 307. Naf is a service-based interface provided by AF 308. Nnrf is a service-based interface provided by the NRF 303.

Nnssf is a service-based interface provided by the NSSF 304. Nausf is a service-based interface provided by the AUSF 309. Nucmf is a service-based interface provided by the UCMF 310.

Nlmf is a service-based interface provided by the LMF 311. Nnsacf is a service-based interface provided by the NSACF 312.

Each NF can receive a response or notification from a service provided by another network function by requesting for or subscribing to the service. That is, each NF exchanges information with another NF by means of request/response or subscription/ notification via a respective service-based interface.

A user plane function (UPF) 330 has a user plane processing function. The DN 340 has a function of enabling connection to a service unique to a mobile network operator (MNO), the Internet, or a third-party service.

The UPF 330 functions as a transfer processing unit for user plane data processed by the application server 40. The UPF 330 also functions as a gateway connected to the (R)AN 20.

Here, in the 5GS, each NF of the 5GC 30 can be configured by virtualization or container and implemented in a cloud server. Furthermore, in the 5GS, each NF can be dynamically and reconfigurably configured by using a software defined network (SDN).

The (R)AN 20 has a function of enabling connection to a RAN and connection to an AN other than the RAN. The (R)AN 20 includes a base station called a gNB or an ng-eNB. The RAN may also be referred to as a next generation (NG)-RAN.

Furthermore, the functions of the (R)AN 20 are divided into a central unit (CU) that processes L2/L3 functions of packet data convergence protocol (PDCP) sublayers and higher, and a distributed unit (DU) that processes L2/L1 functions of radio link control (RLC) sublayers and lower. The functions of the (R)AN 20 may be respectively distributed and arranged via an F1 interface.

Further, the functions of the DU are divided into a radio unit (RU) that processes a LOW PHY sublayer, and a DU that processes respective sublayers of RLC, medium access control (MAC), and high PHY.

The functions of the RU may be distributed and arranged, for example, via a fronthaul compliant with an evolved Common Public Radio Interface (eCPRI).

Here, in the 5GS, the functions of the CU and/or the DU can be configured by virtualization or container and implemented in a cloud server. Further, the 5GS can dynamically and reconfigurably configure the functions of the CU and/or the DU by using the SDN.

The UE 10 and the AMF 301 mutually exchange information via a reference point N1. Information exchange is performed between the (R)AN 20 and the AMF 301 via a reference point N2. Information exchange is performed between the SMF 306 and the UPF 330 via a reference point N4.

### 2-2. Example of Configuration of Information Processing Device

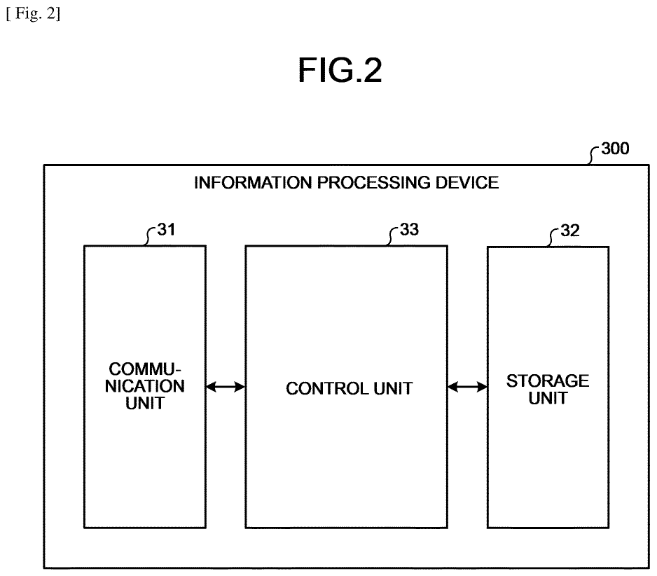

Next, an example of a configuration of an information processing device 300 according to an embodiment of the present disclosure will be described with reference to FIG. 2. FIG. 2 is a block diagram illustrating an example of the configuration of the information processing device 300 according to an embodiment of the present disclosure.

The information processing device 300 is a device that implements the functions of the NF, the AF 308, and the application server 40 of the core network 30. The information processing device 300 is, for example, a server device. The information processing device 300 may be a device collectively referred to as a cloud server or an edge server.

As illustrated in FIG. 2, the information processing device 300 includes a communication unit 31, a storage unit 32, and a control unit 33. Note that the configuration illustrated in FIG. 2 is a functional configuration, and a hardware configuration may be different from this. Further, the functions of the information processing device 300 may be distributed to and implemented in a plurality of physically separated components. For example, the information processing device 300 may be implemented by a plurality of server devices.

The communication unit 31 is a communication interface for performing communication with another device. The communication unit 31 may be a network interface or may be an equipment connection interface. For example, the communication unit 31 may be a local area network (LAN) interface such as a network interface card (NIC), or may be a universal serial bus (USB) interface including a USB host controller, a USB port, and the like. Further, the communication unit 31 may be a wired interface or a wireless interface. The communication unit 31 functions as communication means of the information processing device 300. The communication unit 31 communicates with the base station 20, another NF node, or an AN node under the control of the control unit 33.

The storage unit 32 is a storage device, from which data can be read and in which data can be written, such as a dynamic random access memory (DRAM), a static random access memory (SRAM), a flash memory, or a hard disk. The storage unit 32 functions as storage means of the information processing device 300.

The control unit 33 is a controller that controls each unit of the information processing device 300. The control unit 33 is implemented by, for example, a processor such as a central processing unit (CPU), a micro processing unit (MPU), or a graphics processing unit (GPU). For example, the control unit 33 is implemented in a manner in which the processor executes various programs stored in the storage device inside the information processing device 300 by using a random access memory (RAM) or the like as a work area. Note that the control unit 33 may be implemented by an integrated circuit such as an application specific integrated circuit (ASIC) or a field programmable gate array (FPGA). The CPU, the MPU, the GPU, the ASIC, and the FPGA can all be regarded as the controller.

### 2-3. Example of Configuration of Base Station

Next, the base station 20 will be described. The base station 20 is a communication device that operates a cell and provides a wireless communication service to one or more terminal devices 10 located inside the coverage of the cell. The cell can be operated according to any wireless communication scheme such as LTE or New Radio (NR). The base station 20 is connected to the core network 30. The core network 30 is connected to a packet data network via a gateway device. In addition, the base station 20 operates a beam identifiable by a synchronization signal/PBCH block (SSB), and transmits and receives data to and from one or more terminal devices 10 via one or more beams.

Note that the base station 20 may include a set of a plurality of physical or logical devices. For example, in an embodiment of the present disclosure, the base station 20 is classified into a plurality of devices including a baseband unit (BBU) and a radio unit (RU), and may be interpreted as a set of these plurality of devices. In addition or instead, in the embodiments of the present disclosure, the base station 20 may be either or both of the BBU and the RU. The BBU and the RU may be connected by a predetermined interface (for example, eCPRI). In addition or instead, the RU may be referred to as a remote radio unit (RRU) or a Radio DoT (RD). In addition or instead, the RU may correspond to a gNB distributed unit (gNB-DU) described below. In addition or instead, the BBU may correspond to a gNB-CU described below. Instead, the RU may be connected to the gNB-DU described below. In addition, the BBU may correspond to a combination of the gNB-CU and the gNB-DU described below. In addition or instead, the RU may be a device integrally formed with an antenna. An antenna of the base station 20 (for example, the antenna integrally formed with the RU) may adopt an advanced antenna system and support MIMO (for example, FD-MIMO) or beamforming. In the advanced antenna system, the antenna of the base station 20 (for example, the antenna integrally formed with the RU) may include, for example, 64 transmission antenna ports and 64 reception antenna ports.

Further, a plurality of base stations 20 may be connected to each other. One or more base stations 20 may be included in the radio access network (RAN). That is, the base station 20 may be simply referred to as a RAN, a RAN node, an access network (AN), or an AN node. The RAN in the LTE is referred to as an enhanced universal terrestrial RAN (EUTRAN). The RAN in the NR is referred to as an NGRAN. The RAN in W-CDMA (UMTS) is referred to as a UTRAN. The base station 20 in the LTE is referred to as an evolved node B (eNodeB) or an eNB. That is, the EUTRAN includes one or more eNodeBs (eNBs). Further, the base station 20 in the NR is referred to as a gNodeB or a gNB. That is, the NGRAN includes one or more gNBs. Further, the EUTRAN may include a gNB (en-gNB) connected to the core network (EPC) in the communication system (EPS) of the LTE. Similarly, the NGRAN may include an ng-eNB connected to the core network (5GC) in the 5G communication system (5GS).

In addition or instead, in a case where the base station 20 is an eNB, a gNB, or the like, the base station may be referred to as 3GPP access. In addition or instead, in a case where the base station 20 is a wireless access point (e.g., an access point of WiFi (registered trademark)), the base station 20 may be referred to as non-3GPP access. In addition or instead, the base station 20 may be an optical feeder device which is called a remote radio head (RRH). In addition or instead, in a case where the base station 20 is a gNB, the base station 20 may be referred to as a combination of a gNB central unit (CU) and a gNB distributed unit (DU) described above or any of them. The gNB central unit (CU) hosts a plurality of higher layers (for example, radio resource control (RRC), service data adaptation protocol (SDAP), and PDCP) of the access stratum for communication with the UE 10. On the other hand, the gNB-DU hosts a plurality of lower layers (for example, RLC, MAC, and PHY) of the access stratum. That is, among messages and information to be described later, RRC signaling (for example, various system information blocks (SIB) including a master information block (MIB) and an SIB1, an RRCSetup message, and an RRCReconfiguration message) may be generated by the gNB CU, while a downlink control indicator (DCI) and various physical channels (for example, a PDCCH and a PBCH) to be described later may be generated by the gNB-DU. Alternatively, in the RRC signaling, for example, some configurations (configuration information) such as IE: cellGroupConfig may be generated by the gNB-DU, and the remaining configurations may be generated by the gNB-CU. These configurations (configuration information) may be transmitted and received by an F1 interface to be described later. The base station 20 may be configured to be able to perform communication with another base station 20. For example, in a case where a plurality of base stations 20 are eNBs or a combination of eNBs and en-gNBs, the base stations 20 may be connected by an X2 interface. In addition or instead, in a case where a plurality of base stations 20 are eNBs or a combination of ng-eNBs and gNBs, the devices may be connected by an Xn interface. In addition or instead, in a case where a plurality of base stations 20 are a combination of gNB CUs and gNB DUs, the devices may be connected by the above-described F1 interface. The messages/information (RRC signalling, DCI information, or physical channel) to be described later may be communicated between a plurality of base stations 20 (for example, via the X2, Xn, or F1 interface).

Further, as described above, the base station 20 may be configured to manage a plurality of cells. A cell provided by the base station 20 is called a serving cell. The serving cell includes a primary cell (PCell) and a secondary cell (SCell). In a case where Dual Connectivity (for example, EUTRA-EUTRA Dual Connectivity, EUTRA-NR Dual Connectivity (ENDC), EUTRA-NR Dual Connectivity with 5GC, NR-EUTRA Dual Connectivity (NEDC), or NR-NR Dual Connectivity) is provided to the UE (for example, terminal device 10), the PCell and zero or one or more SCell(s) provided by a master node (MN) are referred to as a master cell group. Further, the serving cell may include a primary secondary cell or a primary SCG Cell (PSCell). That is, in a case where the Dual Connectivity is provided to the UE 10, the PSCell and zero or one or more SCell(s) provided by a secondary node (SN) are referred to as a secondary cell group (SCG). Unless specially configured (for example, physical uplink control channel (PUCCH) on SCell), the PUCCH is transmitted by the PCell and the PSCell, not by the SCell. Radio link failure is detected in the PCell and the PSCell, and is not detected (does not have to be detected) in the SCell. Since the PCell and the PSCell have a special role in the serving cell(s) as described above, they are also called special cells (SpCells). One downlink component carrier and one uplink component carrier may be associated with one cell. Further, a system bandwidth corresponding to one cell may be divided into a plurality of bandwidth parts. In this case, one or more bandwidth parts (BWPs) may be set in the UE 10 and one bandwidth part may be used in the UE 10 as an active BWP. Further, radio resources (for example, a frequency band, numerology (subcarrier spacing), and slot configuration) that can be used by the terminal device 10 may be different for each cell, each component carrier, or each BWP.

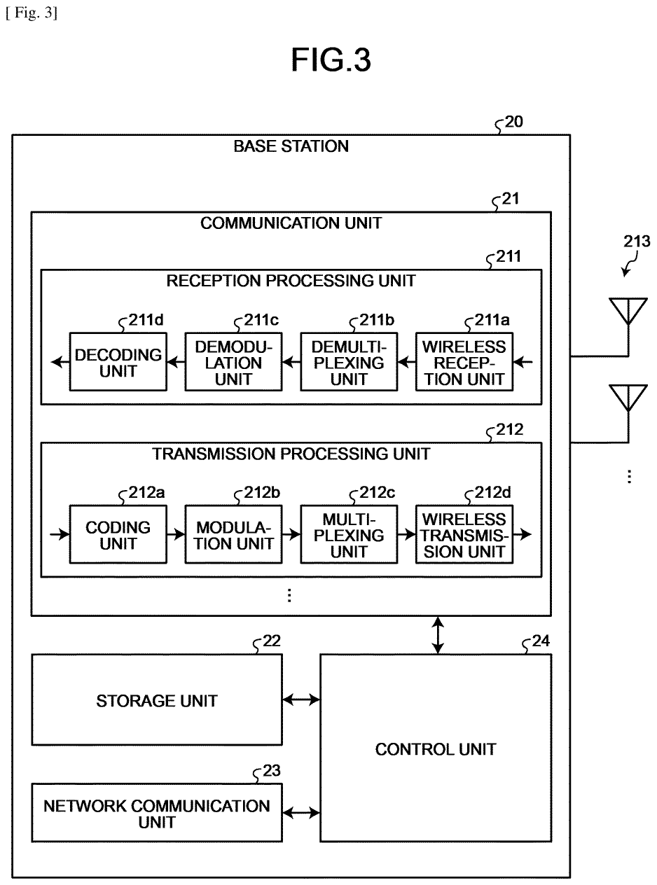

FIG. 3 is a diagram illustrating an example of a configuration of the base station 20 according to an embodiment of the present disclosure. The base station 20 is a communication device (wireless system) that performs wireless communication with the terminal device 10. The base station 20 is a type of information processing device.

The base station 20 includes a communication unit 21, a storage unit 22, a network communication unit 23, and a control unit 24. Note that the configuration illustrated in FIG. 3 is a functional configuration, and a hardware configuration may be different from this. Further, the functions of the base station 20 may be distributed to and implemented in a plurality of physically separated devices. For example, as described above, the functions of the base station 20 are distributed to the CU and the DU, or the CU, the DU, and the RU.

The communication unit 21 is a wireless communication interface (signal processing unit) that performs wireless communication with other communication devices (for example, the terminal device 10 and another base station 20). The communication unit 21 is a wireless transceiver that operates under the control of the control unit 24. The communication unit 21 may support a plurality of radio access schemes. For example, the communication unit 21 may support both NR and LTE. The communication unit 21 may support another cellular communication scheme such as W-CDMA or cdma2000. Further, the communication unit 21 may support a wireless LAN communication scheme in addition to the cellular communication scheme. It is a matter of course that the communication unit 21 may only support one radio access scheme.

The communication unit 21 includes a reception processing unit 211, a transmission processing unit 212, and an antenna 213. The communication unit 21 may include a plurality of reception processing units 211, a plurality of transmission processing units 212, and a plurality of antennas 213. Note that, in a case where the communication unit 21 supports a plurality of radio access schemes, each unit of the communication unit 21 can be individually configured for each radio access scheme. For example, in a case where the base station 20 supports NR and LTE, the reception processing unit 211 and the transmission processing unit 212 may be individually configured for each of NR and LTE.

The reception processing unit 211 processes an uplink signal received via the antenna 213. The reception processing unit 211 includes a wireless reception unit 211a, a demultiplexing unit 211b, a demodulation unit 211c, and a decoding unit 211d.

The wireless reception unit 211a performs, on the uplink signal, down-conversion, removal of an unnecessary frequency component, a control of an amplification level, quadrature demodulation, conversion into a digital signal, removal of a guard interval, extraction of a frequency domain signal by fast Fourier transform, and the like. For example, it is assumed that the radio access scheme of the base station 20 is a cellular communication scheme such as LTE. At this time, the demultiplexing unit 211b separates an uplink channel such as a physical uplink shared channel (PUSCH) or physical uplink control channel (PUCCH) and an uplink reference signal from a signal output from the wireless reception unit 211a. The demodulation unit 211c performs demodulation of a reception signal for a modulation symbol of the uplink channel by using a modulation scheme such as binary phase shift keying (BPSK) or quadrature phase shift keying (QPSK). The modulation scheme used by the demodulation unit 211 c may be multi-level QAM such as 16-quadrature amplitude modulation (QAM), 64-QAM, or 256-QAM. The decoding unit 211d performs decoding processing on a coded bit of the demodulated uplink channel. Decoded uplink data and uplink control information are output to the control unit 24.

The transmission processing unit 212 performs transmission processing of downlink control information and downlink data. The transmission processing unit 212 includes a coding unit 212a, a modulation unit 212b, a multiplexing unit 212c, and a wireless transmission unit 212d.

The coding unit 212a codes the downlink control information and the downlink data input from the control unit 24 by using a coding method such as block coding, convolutional coding, or turbo coding. Here, the coding unit 212a may perform coding with a polar code and coding with a low density parity check code (LDPC code). The modulation unit 212b modulates the coded bit output from the coding unit 212a by a predetermined modulation scheme such as BPSK, QPSK, 16-QAM, 64-QAM, or 256-QAM. The multiplexing unit 212c multiplexes a modulation symbol of each channel and a downlink reference signal, and maps them to a predetermined resource element. The wireless transmission unit 212d performs various kinds of signal processing on a signal from the multiplexing unit 212c. For example, the wireless transmission unit 212d performs processing such as conversion into the time domain by fast Fourier transform, addition of a guard interval, generation of a baseband digital signal, conversion into an analog signal, quadrature modulation, up-conversion, removal of extra frequency components, or power amplification. A signal generated by the transmission processing unit 212 is transmitted from the antenna 213.

The storage unit 22 is a storage device, from which data can be read and in which data can be written, such as a DRAM, an SRAM, a flash memory, or a hard disk. The storage unit 22 functions as a storage means of the base station 20.

The network communication unit 23 is a communication interface for communicating with other devices (for example, another base station 20). For example, the network communication unit 23 is a LAN interface such as an NIC. The network communication unit 23 may be a USB interface including a USB host controller, a USB port, and the like. Further, the network communication unit 23 may be a wired interface or a wireless interface. The network communication unit 23 functions as a network communication means of the base station 20. The network communication unit 23 performs communication with another device under the control of the control unit 24.

The control unit 24 is a controller that controls each unit of the base station 20. The control unit 24 is implemented by, for example, a processor such as a CPU, an MPU, or a GPU. For example, the control unit 24 is implemented in a manner in which the processor executes various programs stored in the storage device inside the base station 20 by using a RAM or the like as a work area. Note that the control unit 24 may be implemented by an integrated circuit such as an ASIC or a FPGA. The CPU, the MPU, the GPU, the ASIC, and the FPGA can all be regarded as the controller.

### 2-4. Example of Configuration of Terminal Device

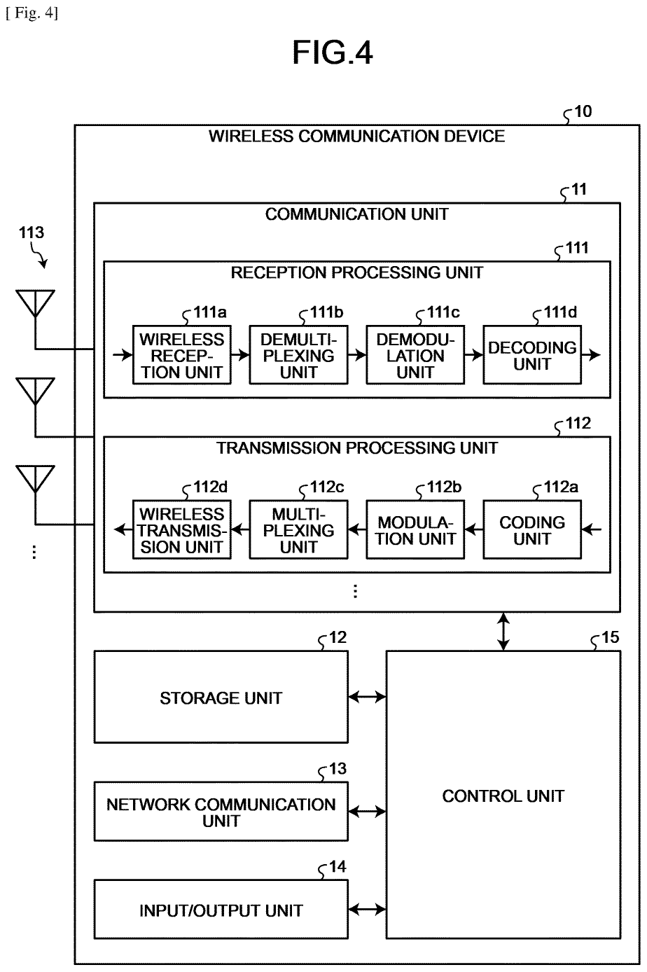

An example of a configuration of the terminal device 10 according to an embodiment of the present disclosure will be described with reference to FIG. 4. FIG. 4 is a block diagram illustrating an example of the configuration of the terminal device 10 according to an embodiment of the present disclosure.

The terminal device 10 is a wireless communication device that performs, for example, wireless communication with the base station 20. The terminal device 10 is, for example, a mobile phone, a smart device (smartphone or tablet PC), a personal digital assistant (PDA), or a personal computer. The terminal device 10 may be a head mounted display having a function of wirelessly transmitting and receiving data, VR goggles, smartglasses, or the like.

Furthermore, the terminal device 10 may be able to perform sidelink communication with another terminal device 10. When performing the sidelink communication, the terminal device 10 may be able to use automatic retransmission technology such as hybrid automatic repeat request (HARQ). The terminal device 10 may be capable of non-orthogonal multiple access (NOMA) communication with the base station 20. The terminal device 10 may also be able to perform the NOMA communication for communication (sidelink) with another terminal device 10. Furthermore, the terminal device 10 may be able to perform low power wide area (LPWA) communication with another communication device (for example, the base station 20 and another terminal device 10). In addition, wireless communication used by the terminal device 10 may be wireless communication using millimeter waves. Note that the wireless communication (including the sidelink communication) used by the terminal device 10 may be wireless communication using radio waves or may be (optical) wireless communication using infrared rays or visible light.

The terminal device 10 may be simultaneously connected to a plurality of base stations 20 or a plurality of cells to perform communication. For example, in a case where one base station 20 can provide a plurality of cells, the terminal device 10 may perform carrier aggregation by using one cell as the pCell and using another cell as the sCell. Furthermore, in a case where each of a plurality of base stations 20 can provide one or more cells, the terminal device 10 can implement dual connectivity (DC) by using one or more cells managed by one base station 20 (master node (MN) (for example, MeNB or MgNB)) as the pCell (PSCell) or the pCell (PSCell) and the sCell(s), and by using one or more cells managed by the other base station 20 (secondary node (SN) (for example, SeNB or SgNB)) as the pCell or the pCell and the sCell(s). The DC may be referred to as multi-connectivity (MC).

For example, in a case of supporting a communication area via cells (a plurality of cells having different cell identifiers or the same identifier) of different base stations 20, it is possible to bundle the plurality of cells and enable communication between the base station 20 and the terminal device 10 by using a carrier aggregation (CA) technology, a dual connectivity (DC) technology, or a multi-connectivity (MC) technology. Alternatively, the terminal device 10 and the plurality of base stations 20 can perform communication with each other by using coordinated multi-point transmission and reception (CoMP) technology via cells of different base stations 20.

The terminal device 10 includes a communication unit 11, a storage unit 12, a network communication unit 13, an input/output unit 14, and a control unit 15. Note that the configuration illustrated in FIG. 4 is a functional configuration, and a hardware configuration may be different from this. Further, the functions of the terminal device 10 may be distributed to and implemented in a plurality of physically separated components.

The communication unit 11 is a signal processing unit for wirelessly communicating with another wireless communication device (for example, the base station 20 or another terminal device 10). The communication unit 11 operates under the control of the control unit 15. The communication unit 11 may be a wireless transceiver supporting one or more radio access schemes. For example, the communication unit 11 supports both NR and LTE. The communication unit 11 may support W-CDMA or cdma2000 in addition to NR or LTE. Furthermore, the communication unit 11 may support the NOMA communication.

The communication unit 11 includes a reception processing unit 111, a transmission processing unit 112, and an antenna 113. The communication unit 11 may include a plurality of reception processing units 111, a plurality of transmission processing units 112, and a plurality of antennas 113. The configurations of the communication unit 11, the reception processing unit 111, the transmission processing unit 112, and the antenna 113 are similar to those of the communication unit 21, the reception processing unit 211, the transmission processing unit 212, and the antenna 213 of the base station 20.

The storage unit 12 is a storage device, from which data can be read and in which data can be written, such as a DRAM, an SRAM, a flash memory, or a hard disk. The storage unit 12 functions as storage means of the terminal device 10.

The network communication unit 13 is a communication interface for communicating with other devices connected via a network. For example, the network communication unit 13 is a LAN interface such as an NIC. Further, the network communication unit 13 may be a wired interface or a wireless interface. The network communication unit 13 functions as network communication means of the terminal device 10. The network communication unit 13 performs communication with another device under the control of the control unit 15.

The input/output unit 14 is a user interface for exchanging information with the user. For example, the input/output unit 14 is an operation device for the user to perform various operations, such as a keyboard, a mouse, an operation key, or a touch panel. Alternatively, the input/output unit 14 is a display device such as a liquid crystal display or an organic electroluminescence (EL) display. The input/output unit 14 may be an audio device such as a microphone, a speaker, or a buzzer. Further, the input/output unit 14 may be a lighting device such as a light emitting diode (LED) lamp. The input/output unit 14 functions as input/output means (input means, output means, operation means, or notification means) of the terminal device 10. For example, in a case where the terminal device 10 is a sensor or the like, the input/output unit 14 may be omitted.

The control unit 15 is a controller that controls each unit of the terminal device 10. The control unit 15 is implemented by, for example, a processor such as a CPU, an MPU, or a GPU. For example, the control unit 15 is implemented in a manner in which the processor executes various programs stored in the storage device inside the terminal device 10 by using a RAM or the like as a work area. Note that the control unit 15 may be implemented by an integrated circuit such as an ASIC or a FPGA. The CPU, the MPU, the GPU, the ASIC, and the FPGA can all be regarded as the controller.

### 2-5. 5G System for Roaming

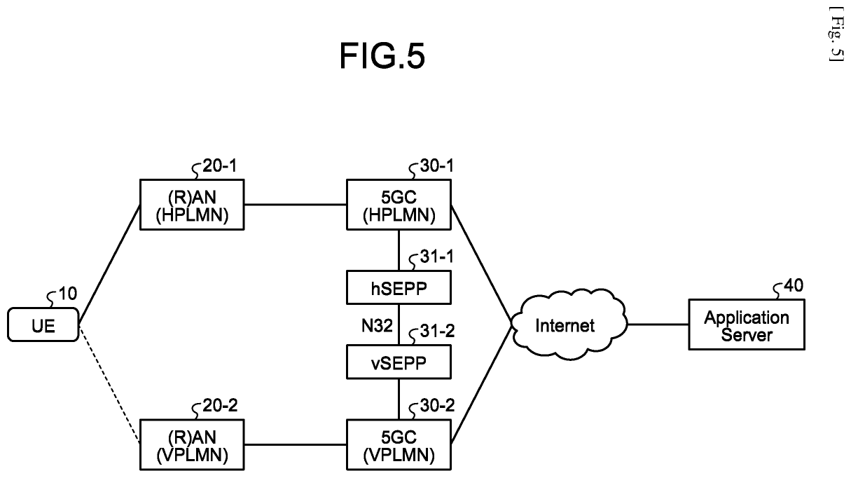

FIG. 5 is a diagram illustrating an example of a configuration of a network architecture of the 5G system for roaming.

The visitor PLMN (VPLMN) having the SLA with the home PLMN (HPLMN) provides the 5G service to the UE 10 by roaming. The 5GS of the HPLMN includes a (R)AN 20-1 and a 5GC 30-1. The 5GS of the VPLMN includes a (R)AN 20-2 and a 5GC 30-2. In FIG. 5, the provision of the 5G service by the roaming is indicated by a dotted line.

The UE 10 accesses the service provided by the application server 40 via the 5G service of the HPLMN by the (R)AN 20-1 and the 5GC 30-1.

In addition, the UE 10 accesses the service provided by the application server 40 via the 5G service of the VPLMN by the (R)AN 20-2 and the 5GC 30-2 using the roaming.

A control plane of the 5GC 30-1 of the HPLMN and a control plane of the 5GC 30-2 of the VPLMN are connected via a security edge protection proxy (SEPP). A home SEPP (hSEPP) 31-1 of the control plane of the 5GC 30-1 and a visitor SEPP (vSEPP) 31-2 of the control plane of the 5GC 30-2 are connected via a reference point N32.

In a case where each NF of the control plane of the 5GC 30-1 of the HPLMN and each NF of the control plane of the 5GC 30-2 of the VPLMN are distinguished from each other, “−1” or “−2” is added to the end of the reference numeral of each NF. “−1” is added to the end of the reference numeral of each NF of the control plane of the 5GC 30-1 of the HPLMN. “−2” is added to the end of the reference numeral of each NF of the control plane of the 5GC 30-2.

The NF of the control plane of the 5GC 30-1 can request for the service provided by the NF of the control plane of the 5GC 30-2 via an NEF 302-2 of the 5GC 30-2 according to the SLA with the VPLMN. Note that the VPLMN may allow the NF of the control plane of the 5GC 30-1 to directly access the NF of the control plane of the 5GC 30-2 to request for the service according to the condition of the SLA.

The NF of the control plane of the 5GC 30-2 may request for the service provided by the NF of the control plane of the 5GC 30-1 via an NEF 302-1 of the 5GC 30-1 according to the SLA with the HPLMN. Note that the HPLMN may allow the NF of the control plane of the 5GC 30-2 to directly access the NF of the control plane of the 5GC 30-1 to request for the service according to the condition of the SLA.

During the roaming, the user plane of the 5GC 30-2 is connected to the application server 40 in the form of local breakout roaming or in the form of home routed roaming.

In the form of local breakout roaming, a UPF 330-2c of the 5GC 30-2 is directly connected to the application server 40. In the form of home routed roaming, the UPF 330-2 of the 5GC 30-2 is connected to a UPF 330-1 of the 5GC 30-1 via a reference point N9, and is connected to the application server 40 via the UPF 330-1 of the 5GC 30-1.

### 3. Related Technologies

### 3-1. Network Slice Selection Assistance Information (NSSAI)

The network slice is a unit of service obtained by dividing the communication service provided by the 5G according to a communication attribute (for example, a data rate, latency, or the like) required for each service.

The S-NSSAI is allocated to each network slice as information for assisting network slice selection (network slice selection assistance information).

The S-NSSAI includes a set of a mandatory slice/service type (SST) and an optional slice differentiator (SD). The mandatory SST includes 8-bit data for identifying a slice type. An arbitrary SD includes 24-bit data for distinguishing different slices of the same SST.

A standardized SST or a non-standardized unique SST can be used as the S-NSSAI. In a case of using a standardized S-NSSAI value, the S-NSSAI includes only the standardized SST without the SD.

On the other hand, in a case of using a non-standardized S-NSSAI value, the S-NSSAI includes the standardized SST and the SD, includes the non-standardized SST and the SD, or includes only the non-standardized SST. The non-standardized S-NSSAI value can only be used within the PLMN that is uniquely using the non-standardized S-NSSAI value, that is, a telecommunication operator.

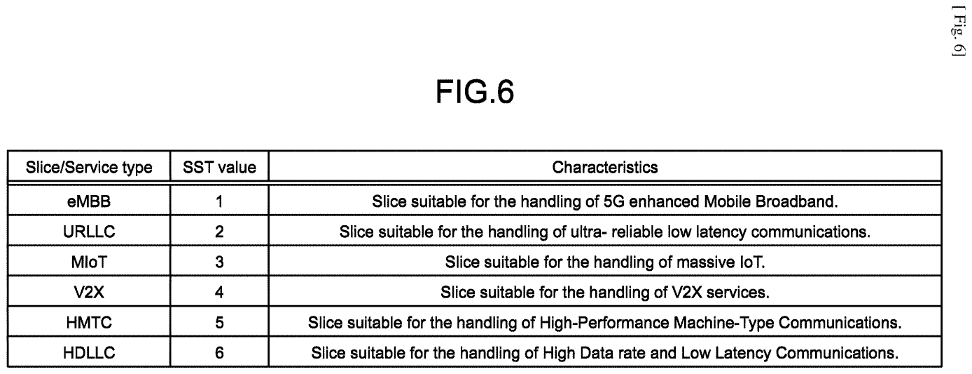

FIG. 6 is a table illustrating the standardized SST values. The table is based on the table in Literature “3GPP TS23.501”. The “case of using the standardized S-NSSAI value” described above corresponds to a case of using S-NSSAI values including only these SST values (enhanced Mobile BroadBand (eMBB): 1, ultra-reliable and low latency communications (URLLC): 2, Massive Internet of Things (MIOT): 3, vehicle-to-everything (V2X): 4, HMTC: 5, and high data rate and low latency communications (HDLLC): 6).

That is, the non-standardized S-NSSAI value is used for other network slices, for example, network slices subdivided by the SD.

Network slice configuration information includes one or more configured NSSAI(s). A serving PLMN may configure the configured NSSAI applied for each PLMN in the UE 10. Alternatively, the home PLMN (HPLMN) may configure default configured NSSAI in the UE 10. The UE 10 under the serving PLMN may use the default configured NSSAI only in a case where the configured NSSAI for the serving PLMN is not configured in the UE 10.

Note that the default configured NSSAI may be configured in the UE 10 in advance. In addition, the UDM 307 of the HPLMN may provide or update the default configured NSSAI by using UE parameters update through UDM control plane processing.

The configured NSSAI includes one or more S-NSSAI(s).

Requested NSSAI is NSSAI provided from the UE 10 to the serving PLMN in registration processing. The requested NSSAI must be one of the followings.
default configured NSSAI
configured NSSAI
allowed NSSAI or part thereof
NSSAI obtained by adding one or more S-NSSAIs included in configured NSSAI to allowed NSSAI or part thereof

The allowed NSSAI is, for example, NSSAI provided by the serving PLMN to the UE 10 in the registration processing. The allowed NSSAI indicates a value of one or more S-NSSAI(s) available in the current registration area of the current serving PLMN.

Rejected S-NSSAI indicates a value of S-NSSAI that is not allowed to be used in at least one tracking area in the current registration area of the current serving PLMN, among the one or more S-NSSAIs included in the requested NSSAI.

Here, the tracking area is an area used for mobility management, and is identified by a tracking area identity (TAI). The network (PLMN) manages the location of the UE 10 within a range of a set of tracking areas on which the UE 10 camps in such a way that a message or data can be transmitted to the UE 10 in an RRC_IDLE state.

When the UE 10 is registered in the network, the AMF 301 allocates a set of tracking areas included in a TAI list as an area (registration area) in which the UE 10 is registered. That is, the network manages that the registered UE 10 resides in any of the tracking areas in the TAI list.

If a more optimal cell is detected according to cell reselection criteria, the UE 10 reselects the cell and camps on the cell. At this time, in a case where the selected cell does not belong to any tracking area in the TAI list in which the UE 10 is registered, location registration processing, that is, processing of updating the TAI list is performed.

The subscribed S-NSSAI is S-NSSAI that can be used in the PLMN by the UE 10 according to subscription information. The subscription information must include one or more subscribed S-NSSAIs, and must include at least one default S-NSSAI.

The UDM 307 transmits up to 16 subscribed S-NSSAIs to the AMF 301. Therefore, the number of S-NSSAIs that can be included in the configured NSSAI is 16. The subscription information transmitted by the UDM 307 to the AMF 301 must include at least one default S-NSSAI.

The NSSF 304 determines the allowed NSSAI and the configured NSSAI, and determines an AMF set which is a list of candidates of the AMF 301. For example, the AMF 301 may be selected from the list of candidates according to the network slice used by the UE 10 or other criteria, and the UE 10 may be allocated to the selected AMF 301.

The one or more S-NSSAI(s) included in the allowed NSSAI provided to the UE 10 may include values that are not part of the current network slice configuration information of the UE 10 for the serving PLMN. In this case, the network provides mapping between respective S-NSSAIs of the allowed NSSAI and corresponding S-NSSAIs of the HPLMN according to the allowed NSSAI.

With information related to the mapping, the UE 10 can associate the application with the S-NSSAI of the HPLMN and the corresponding S-NSSAI of the allowed NSSAI for each network slice selection policy (NSSP) of a UE route selection policy (URSP) rule. Alternatively, the UE 10 can associate the application with the S-NSSAI of the HPLMN and the corresponding S-NSSAI of the allowed NSSAI for each local configuration of the UE 10.

For example, if where the HPLMN and/or the visitor PLMN (VPLMN) use the non-standardized S-NSSAI value, the UE 10 needs to provide the information related to the mapping during the roaming. The information related to the mapping includes mapping of the value of the S-NSSAI included in the requested NSSAI and the corresponding value of the S-NSSAI used in the HPLMN.

Here, the information related to the mapping may be acquired by the UE 10 in advance from the serving PLMN as mapping of the value of the S-NSSAI included in the configured NSSAI for the serving PLMN and the corresponding value of the S-NSSAI used in the HPLMN.

Alternatively, the information related to the mapping may be acquired by the UE 10 in advance from the serving PLMN as mapping of the value of the S-NSSAI included in the allowed NSSAI for the serving PLMN and an access type and the corresponding value of the S-NSSAI used in the HPLMN.

In addition, the UE 10 can support a contract-based restriction function for network slices that can be registered simultaneously. In a case of supporting this function, the UE 10 includes, as a part of UE 5GMM Core Network Capability, information indicating that the function is supported, in a registration request message at the time of initial registration and mobility registration update.

When providing the configured NSSAI to the UE 10 notifying that the contract-based restriction function for network slices that can be registered simultaneously is supported, the AMF 301 provides information related to a network slice simultaneous registration group (NSSRG) related to the network slice (S-NSSAI(s)) of the HPLMN to the UE 10.

The subscription information including the NSRRG information must include at least one default S-NSSAI. In a case where a plurality of default S-NSSAIs are configured, the default S-NSSAIs are associated with the same NSRRG. That is, the UE 10 is allowed to simultaneously register all the default S-NSSAIs.

The HPLMN does not have to transmit the NSRRG information as the subscription information to the VPLMN. The HPLMN may transmit, to the VPLMN, at least another subscribed S-NSSAI that shares all NSSRGs defined for the default S-NSSAI, in addition to the default S-NSSAI.

The UE 10 that has received the NSSRG needs to include only the network slices (S-NSSAIs) allocated to one common NSSRG in the requested NSSAI.

Furthermore, in a case where a boundary of a service area of the network slice does not coincide with a boundary of the tracking area, additional restrictions on the use of the network slice in the tracking area can be defined using network slice location availability information (S-NSSAI location availability information).

For example, in a case where the S-NSSAI of the configured NSSAI is not in an available state in all cells in the tracking area of the registration area, the network slice location availability information is provided to the UE 10. The network slice location availability information includes location information (for example, a cell ID) indicating a cell in which the S-NSSAI is available in the tracking area.

The AMF 301 may determine target NSSAI by itself or in cooperation with the NSSF 304. The target NSSAI is used to redirect the UE 10 to a cell of another frequency band supporting the S-NSSAI of the target NSSAI, the tracking area, and another tracking area. The target NSSAI is information used by the NG-RAN 20 in addition to information such as the allowed NSSAI received by the AMF 301 and an RAT/frequency selection priority (RFSP) for the allowed NSSAI.

The target NSSAI includes, from the requested NSSAI, at least one S-NSSAI that is not available in the current tracking area but is available in another tracking area of another frequency band or an area overlapping with the current tracking area of another frequency band.

In addition, the AMF 301 may optionally add, from the requested NSSAI, the S-NSSAI that is not available in the current tracking area but is available in a predetermined tracking area to the target NSSAI. The predetermined tracking area is the same as the tracking area in which the S-NSSAI included in the target NSSAI is available.

The AMF 301 acquires an RAT/frequency selection priority index (RFSP index) suitable for the target NSSAI from the PCF 305. The AMF 301 includes the RFSP index in information to be transmitted to the NG-RAN 20. In a case where the PCF 305 is not installed, the AMF 301 determines the RFSP index according to a locally configured rule.

The NG-RAN 20 maps the RFSP index to a locally defined configuration to apply a separate radio resource management policy that takes into account available information. That is, the NG-RAN 20 may select a setting for the radio resource management policy suitable for the target NSSAI corresponding to the RFSP index.

If the NG-RAN 20 can redirect the UE 10 to a new tracking area supporting either the target NSSAI or any S-NSSAI of the target NSSAI, the RFSP index related to the target NSSAI is considered. If not, the RFSP index of the allowed NSSAI is considered.

The NG-RAN 20 also sets partially allowed NSSAI and/or S-NSSAI rejected partially in the registration area (RA). Thereby, the NG-RAN 20 may provide a partial network slice in the registration area.

While the S-NSSAI of the allowed NSSAI is available in all tracking areas within the registration area, the S-NSSAI of the partially allowed NSSAI is only available in the tracking area corresponding to a list of tracking areas related to the S-NSSAI.

In a case where the UE 10 corresponds to the partial network slice in the registration area, the AMF 301 configures the registration area for the UE 10 in consideration of a support status of the S-NSSAI of the requested NSSAI in the current tracking area and a surrounding tracking area. The AMF 301 provides the partially allowed NSSAI or the S-NSSAI rejected partially in the registration area to the UE 10 by using a registration accept message or a UE configuration update command message.

The AMF 301 provides, for each S-NSSAI of the partially allowed NSSAI, a list of tracking areas in which the S-NSSAI is supported. Alternatively, the AMF 301 may reject the S-NSSAI according to a rejection reason indicating “partially in the RA”.

The AMF 301 provides, for each S-NSSAI of the S-NSSAI partially rejected in the registration area, a list of tracking areas in which the S-NSSAI is supported or not supported.

The AMF 301 may use a network slice replacement function to replace the S-NSSAI with alternative S-NSSAI in a case where the S-NSSAI is not available or experiences a high load.

The AMF 301 can determine to exchange the S-NSSAI with the alternative S-NSSAI based on a notification from the NSSF 304, the PCF 305, or operations, administration and maintenance (OAM).

For the roaming, a V-AMF 301-2 may receive a notification of network slice availability of the S-NSSAI of the HPLMN from an H-NSSF 304-1 of the HPLMN to start the network slice replacement of the S-NSSAI of the HPLMN. In this case, the V-AMF 301-2 receives the notification from the H-NSSF 304-1 via a V-NSSF 304-2 of the VPLMN.

In a case where there is no notification from the NSSF 304 or the PCF 305, or in a case where the NSSF 304 or the PCF 305 does not provide the alternative S-NSSAI, the AMF 301 determines the alternative S-NSSAI for the UE 10 for which the S-NSSAI is registered based on the local configuration.

The alternative S-NSSAI must be supported within the registration area of the UE 10. For example, in a case where the NSSF 304 or the PCF 305 does not provide the alternative S-NSSAI, the AMF 301 cannot determine the alternative S-NSSAI for the S-NSSAI. In this case, the AMF 301 can further negotiate with the PCF 305 to determine the alternative S-NSSAI.

The UE 10 notifies the network of support for the network slice replacement function during the registration processing. The AMF 301 provides, to the UE 10, the allowed NSSAI and the alternative S-NSSAI for the S-NSSAI included in the configured NSSAI.

Accordingly, the AMF 301 can support the UE 10 in a connected mode (CM-CONNECTED mode). In the connected mode, a PDU session related to the S-NSSAI that needs to be exchanged exists in a UE context.

The AMF 301 can also provide mapping information of the S-NSSAI and the alternative S-NSSAI to the UE 10 by using a UE configuration update message.

The AMF 301 transmits the mapping information of the S-NSSAI and the alternative S-NSSAI to the UE 10 by using UE configuration update for the S-NSSAI to be exchanged with the alternative S-NSSAI and the related current PDU session. Thereafter, the AMF 301 instructs the SMF 306 to, for example, start a session management context update (Nsmf_PDUSession_UpdateSMContext) service to update the PDU session required to migrate the PDU session to the alternative S-NSSAI.

In order to support the UE 10 in an idle state (CM-IDLE state), the UE 10 establishes connection of non-access stratum (NAS) signaling via a service request procedure or a UE registration procedure. At this time, the AMF 301 determines to exchange the S-NSSAI.

In a case where the PDU session related to the S-NSSAI exists in the UE context, the AMF 301 provides the mapping information of the S-NSSAI and the alternative S-NSSAI to the UE 10 by using the UE configuration update message or the registration accept message.

### 3-2. QoS Control of 5G System

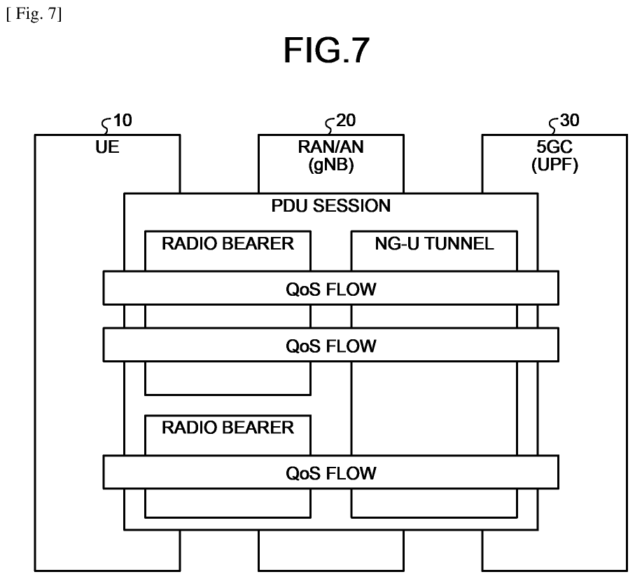

FIG. 7 is a diagram illustrating an example of a QoS architecture of the 5GS. FIG. 7 is based on the drawing in Literature “3GPP TS38.300”.

At a non-access stratum (NAS) level, a QoS flow is the finest granularity in distinguishing different QoS in the protocol data unit (PDU) session. In the PDU session, the QoS flow is identified by a QoS flow ID (QFI).

Furthermore, in an extended reality (XR) or media service, a group of packets is transmitted using a payload of a PDU set. The PDU set includes one or more PDUs that transmit a payload of an information unit generated at an application level.

Examples of the information unit include an image frame, a video slice of the XR or media service, and an I frame, a P frame, and a B frame of moving image data in a group of picture (GOP) format.

Furthermore, in a multimodal application that handles a plurality of types of data such as the XR, each of the plurality of types of data (for example, pose information, audio information, video information, and haptics) may be the information unit.

That is, a packet in the PDU set is treated as a unit of data to be received and decoded within a certain period of time. For example, decoding may be performed only in a case where all the packets transmitting an image frame or a video slice or a certain amount of packets are successfully received. For example, image frames in a GOP can be decoded only in a case where all image frames with dependencies have been successfully received.

The 5GS can identify data at a finer granularity by the PDU set in the QoS flow with a finer granularity in terms of the QoS control. The 5GS may apply the QoS control at a PDU set level in addition to the QoS control at a QoS flow level.

The PCF 305 may associate information of an AF session with the PDU session. The AF 308 may request to establish a data session (for example, the PDU session) for the UE 10 as a session of a particular QoS (for example, low latency or low jitter) via the AF session with the PCF 305.

The SMF 306 associates a policy and charging control (PCC) rule for the QoS flow based on the QoS and a service request. The SMF 306 assigns the QFI for a new QoS flow, and acquires the PCC rule and other information associated with the QoS flow from the PCF 305.

The SMF 306 acquires a QoS profile of the QoS flow, an instruction regarding the corresponding UPF 330 (for example, an N4 rule), and a QoS rule from the PCC rule.

The base station (gNB) of the (R)AN 20 can establish at least one data radio bearer (DRB) with each UE 10 together with the PDU session. The DRB is a logical path for transmitting data.

In a QoS model of the 5G, a guaranteed flow bit rate (GBR) which guarantees bandwidth and a non-guaranteed flow bit rate (non-GBR) which does not guarantee bandwidth are supported. Further, for a time sensitive communication (TSC) QoS flow, a delay-critical GBR is supported.

The (R)AN 20 and the 5GC 30 ensure a quality of service by mapping each packet to an appropriate QoS flow and DRB. That is, two-stage mapping of mapping between an IP flow and the QoS flow in the NAS and mapping between the QoS flow and the DRB in the NAS is performed.

At the NAS level, the QoS flow is characterized by the QoS profile provided from the 5GC 30 to the (R)AN 20 and the QoS rule provided from the 5GC 30 to the UE 10.

The QoS profile is used by the (R)AN 20 to determine a processing method on a radio interface. The QoS rule is used to instruct the UE 10 to map a traffic of the user plane in uplink to the QoS flow.

Therefore, the QoS rule of a multicast/broadcast service (MBS) QoS flow and a QoS parameter at the QoS flow level are not provided to the UE 10 for a multicast MBS session.

The QoS profile is provided from the SMF 306 to the (R)AN 20 via the AMF 301 and the reference point N2. Alternatively, the QoS profile is configured in advance in the (R)AN 20.

In addition, the SMF 306 may provide one or more QoS rules and, if necessary, the QoS parameter at the QoS flow level associated with the QoS rule to the UE 10 via the AMF 301 and the reference point N1.

In addition or instead, reflective QoS control may be applied to the UE 10. The reflective QoS control is QoS control that monitors the QFI of a downlink packet and applies the same mapping to an uplink packet.

The QoS flow is a GBR QoS flow or a non-GBR QoS flow depending on the QoS profile. The QoS profile of the QoS flow includes, for example, the QoS parameters such as the 5G QoS identifier (5QI) and an allocation and retention priority (ARP).

The ARP includes information regarding a priority level, a pre-emption capability, and a pre-emption vulnerability.

The priority level defines a relative importance of the QoS flow. A smaller value of the priority level indicates a higher priority level.

The pre-emption capability is an index that defines whether or not a certain QoS flow can deprive a resource already allocated to another QoS flow with a lower priority level.

The pre-emption vulnerability is an index that defines whether or not a certain QoS flow is able to vacate a resource allocated thereto to another QoS flow with a higher priority level.

Either “enabled” or “disabled” is set as the pre-emption capability and the pre-emption vulnerability.

In the GBR QoS flow, the QoS profile includes:
an uplink and downlink GFBR,
an uplink and downlink maximum flow bit rate (MFBR),
an uplink and downlink maximum packet loss rate,
a delay critical resource type,
a notification control,
   and the like.

In the non-GBR QoS flow, the QoS profile includes a reflective QoS attribute (RQA), additional QoS flow information, and the like.

The notification control of the QoS parameter indicates whether or not a notification from the (R)AN 20 is requested when a certain QoS flow cannot satisfy the GFBR. In a case where, for the GBR QoS flow, it is determined that the notification control is “enabled” and the GFBR cannot be satisfied, the (R)AN 20 transmits a notification of the determination to the SMF 306.

At this time, unless the (R)AN 20 is in a special state of requesting release of a RAN resource of the GBR QoS flow, the (R)AN 20 should maintain the QoS flow.

Examples of the special state include a radio link failure or congestion inside the (R)AN 20 (RAN internal congestion).

Then, in a case where it is determined that the GFBR is satisfied again for the QoS flow, the (R)AN 20 transmits a new notification of the determination to the SMF 306.

An aggregate maximum bit rate (AMBR) is related to a Session-AMBR of each PDU session and a UE-AMBR of each UE 10. The Session-AMBR limits an aggregate bit rate that is expected to be provided across all the non-GBR QoS flows for a particular PDU session. The Session-AMBR is managed by the UPF 330.

The UE-AMBR limits the aggregate bit rate expected to be provided across all the non-GBR QoS flows for the UE 10. The UE-AMBR is managed by the (R)AN 20.

Further, a slice maximum bit rate (S-MBR) related to the network slice (S-NSSAI) may be configured in each UE 10. The S-MBR may be included in the contractor information as a Subscribed UE-Slice-MBR.

The UE-Slice-MBR limits the aggregate bit rate expected to be provided across all the GBR QoS flows and non-GBR QoS flows belonging to all PDU sessions that the UE 10 establishes for the same network slice (S-NSSAI).

The (R)AN 20 receives the UE-Slice-MBR corresponding to the network slice (S-NSSAI) from the AMF 301. The (R)AN 20 configures the Session-AMBR and the MFBR for the UE 10 in such a way that the sum of the Session-AMBRs and the MFBRs of the GBR QoS flows of all PDU sessions belonging to the network slice (S-NSSAI) is the UE-Slice-MBR.

The 5QI relates to a characteristic of the QoS. The 5QI provides a guideline (policy) for configuring a node-specific parameter for each QoS flow. A standardized or pre-configured characteristic of the QoS of the 5G can be known from the 5QI. No explicit signaling of this characteristic is performed. The signaled characteristic of the QoS can be included as a part of the QoS profile.

The characteristic of the QoS includes information regarding a resource type, a priority, a packet delay budget, a packet error rate, an averaging window, a maximum data burst volume, and the like.

The resource type is the GBR QoS flow, the non-GBR QoS flow, or a delay-critical GBR QoS flow. The packet delay budget may include a packet delay budget in the 5GC 30.

At the NAS level, the DRB defines a packet processing method in the radio interface (Uu interface). The DRB provides the same packet transfer processing for any packet.

The (R)AN 20 maps the QoS flow to the DRB based on the QFI and the QoS profile configured in the QFI. The (R)AN 20 may establish different DRBs for packets requesting for different packet transfer processings (see FIG. 7).

The (R)AN 20 can also multiplex a plurality of QoS flows belonging to the same PDU session into the same DRB (see FIG. 7).

In uplink, the mapping of the QoS flow to the DRB is controlled by a mapping rule signaled by two different methods.

One method is a method called reflective mapping. In the reflective mapping, the UE 10 monitors the QFI of the downlink packet for each DRB and applies the same mapping to the uplink packet.

Another method is a method called explicit configuration. In the explicit configuration, a rule of mapping of the QoS flow to the DRB is explicitly signaled by radio resource control (RRC).

In downlink, the QFI is signaled on the Uu interface by the (R)AN 20 for a Reflective Quality of Service (RQoS). However, neither the (R)AN 20 nor the NAS signal the QFI for a certain DRB on the Uu interface unless the reflective mapping is used for the QoS flow carried in the DRB.

In uplink, the (R)AN 20 can configure signaling of the QFI toward the UE 10 on the Uu interface. In addition, the (R)AN 20 can configure a default DRB for each PDU session.

In a case where the uplink packet does not adapt to either the explicit configuration or the reflective mapping, the UE 10 maps the packet to the default DRB of the PDU session.

For the non-GBR QoS flow, the 5GC 30 may transmit an additional QoS flow information parameter related to any QoS flow to the (R)AN 20. This is done to indicate increasing the frequency of a certain traffic relative to other non-GBR QoS flows in the same PDU session.

How to map a plurality of QoS flows in the PDU session to one DRB depends on the (R)AN 20. For example, the (R)AN 20 may map the GBR QoS flow and the non-GBR QoS flow to the same DRB or to different DRBs. Further, the (R)AN 20 may map a plurality of GBR QoS flows to the same DRB or to different DRBs.

In the 5G NR, a service data adaptation protocol (SDAP) sublayer is newly introduced for the QoS control via the QoS flow. A traffic of the QoS flow is mapped to an appropriate DRB by the SDAP sublayer.

The SDAP sublayer may have a plurality of SDAP entities. The SDAP sublayer has an SDAP entity for each PDU session on the Uu interface. The SDAP entity is established or released by the RRC.

The QoS flow is identified by the QFI in a PDU session container included in a GPRS tunneling protocol (GTP)-U header. The PDU session is identified by a GTP-UTEID (tunnel endpoint ID). The SDAP sublayer maps each QoS flow to a specific DRB.

Upon receiving a QoS monitoring request from the AF 308, the PCF 305 generates an authorized QoS monitoring policy. The PCF 305 may provide the QoS monitoring policy to the SMF 306 by including the generated QoS monitoring policy in the PCC rule.

The SMF 306 can activate end-to-end uplink (UL)/downlink (DL) packet delay measurement between the UE 10 and the PSA-UPF 330 for the QoS flow. This activation is performed during a PDU session establishment procedure or during a PDU session modification procedure.

The SMF 306 transmits the QoS monitoring request to the UPF 330 via the reference point N4. The SMF 306 transmits N2 signaling to the UPF 330 to request for QoS monitoring between the UPF 330 and the (R)AN 20.

The SMF 306 requests for QoS monitoring based on the QoS monitoring policy received from the PCF 305 or the authorized QoS monitoring policy that is locally configured in advance. The QoS monitoring request includes a monitoring variable determined by the SMF 306.

The (R)AN 20 measures a delay of the UL/DL packet at the (R)AN 20 portion and provides the measured value to the UPF 330 via the reference point N3.

The UPF 330 calculates a delay of the UL/DL packet at the reference point N3 or N9. The UPF 330 transmits a QoS monitoring result to the SMF 306 based on a predetermined condition. Here, the predetermined condition is, for example, only once, periodically, or an event trigger.

The UPF 330 may also support transmission of the QoS monitoring result to the AF 308 via a locally arranged NEF 302. Here, examples of the QoS monitoring result include:
a result of measuring a bit rate (for example, an average bit rate or maximum bit rate) of each GBR QoS flow for a target PDU session,
a result of measuring an aggregate bit rate of all the non-GBR QoS flows of the target PDU session,
a result of measuring a packet error rate of a target PDU session,
a result of measuring an aggregate bit rate of all the non-GBR QoS flows of the target UE 10,
a result of measuring a packet error rate of the target UE 10,
a result of measuring a delay of the UL/DL packet,
   and the like.

Further, the AF 308 can transmit a packet delay variation monitoring and report request to the PCF 305 together with a packet delay measurement request. Here, the packet delay variation is one definition for evaluating jitter during packet transmission, and is a variation of a packet delay measured between the UE 10 and the PSA-UPF 330.

A request for the packet delay variation may include the followings.
Parameter of measured packet delay variation (UL, DL, or round trip (RT) packet delay variation)
Frequency of reporting (event triggered or periodic)

In response to the packet delay variation monitoring request from the AF 308, the PCF 305 starts QoS monitoring processing to acquire a result of UL, DL, or round trip (RT) QoS monitoring from the SMF 306. The PCF 305 derives the packet delay variation of the 5GS (5 GS packet delay variation) based on the QoS monitoring result and reports the packet delay variation to the AF 308.

The delay of the UL/DL packet is a delay including the delay of the UL/DL packet at the (R)AN 20 portion acquired from the (R)AN 20 and the delay of the UL/DL packet at the reference point N3 or N9.

In addition, in a case where the PDU session is a session via a TSN bridge, a packet delay budget for a TSC QoS flow is the sum of a 5G-AN packet delay budget (PDB) and a core network (CN) PDB.

The above-described QoS monitoring mechanism can also be applied to the TSC QoS flow for measurement of a bit rate (for example, the average bit rate or the maximum bit rate) between the UE 10 and the PSA-UPF 330 and the end-to-end UL/ DL packet delay measurement.

The TSC QoS flow uses the resource type of the delay-critical GBR and TSC assistance information. The TSC QoS flow can use a standardized 5QI, a preset 5QI, or a dynamically assigned 5QI value.

For the TSC QoS flow, it is required to transmit one data burst with a maximum data burst amount in the 5G-AN PDB. A TSC burst size is used to set the maximum data burst amount.

The maximum TSC burst size is treated as the maximum amount of data within a period of time that is equal to the value of the 5G-AN PDB for the 5QI. The maximum value of the TSC burst size is mapped to the 5QI with the maximum data burst amount equal to or greater than the maximum value of the TSC burst size.

PDU set QoS parameters are used to support the QoS control for the PDU set. PDU-set-specific QoS characteristics include:
a PDU set delay budget (PSDB),
a PDU set error rate (PSER), and
PDU set integrated handling information (PSIHI).

The PCF 305 determines the PDU set QoS parameters according to information provided from the AF 308 and/or local settings. The PDU set QoS parameters are transmitted to the SMF 306 as a part of the PCC rule, and the SMF 306 transmits the PDU set QoS parameters to the (R)AN 20 as a part of the QoS profile.

The PDU set delay budget defines an upper limit of a delay that occurs when the PDU set is transmitted between the UE 10 and a termination point of an N6 interface of the UPF 330. That is, the PDU set delay budget is a time from when the first PDU of the PDU set is received to when the last arriving PDU is successfully transmitted. The PDU set delay budget is applied to a DL PDU set received by the PSA-UPF 330 via the N6 interface and an UL PDU set transmitted by the UE 10.

The PDU set error rate defines an upper limit of a ratio of the PDU set not successfully received in a higher layer (for example, the PDCP sublayer of the RAN 20) to a PDU set handled in a link layer (for example, the RLC sublayer of the RAN 20).

One QoS flow is associated with only one PDU set error rate, and the value of the packet error rate is the same in UL and DL. If the PDU set error rate is available, the use of the PDU set error rate is prioritized over the packet error rate.

For the GBR QoS flows with the resource type of the delay-critical GBR, PDU sets that are delayed beyond the PDU set delay budget are counted as lost and included in the PDU set error rate unless the QoS flow exceeds the GFBR.

The PDU set integrated handling information notifies an application layer at a reception side that uses the PDU set whether or not all PDUs of the PDU set are required.

### 4. First Embodiment

Here, a processing example in which the UE 10 acquires the configured NSSAI used in the visitor network, in the visitor network in which the UE resides will be described.

### Registration Processing for Visitor Network

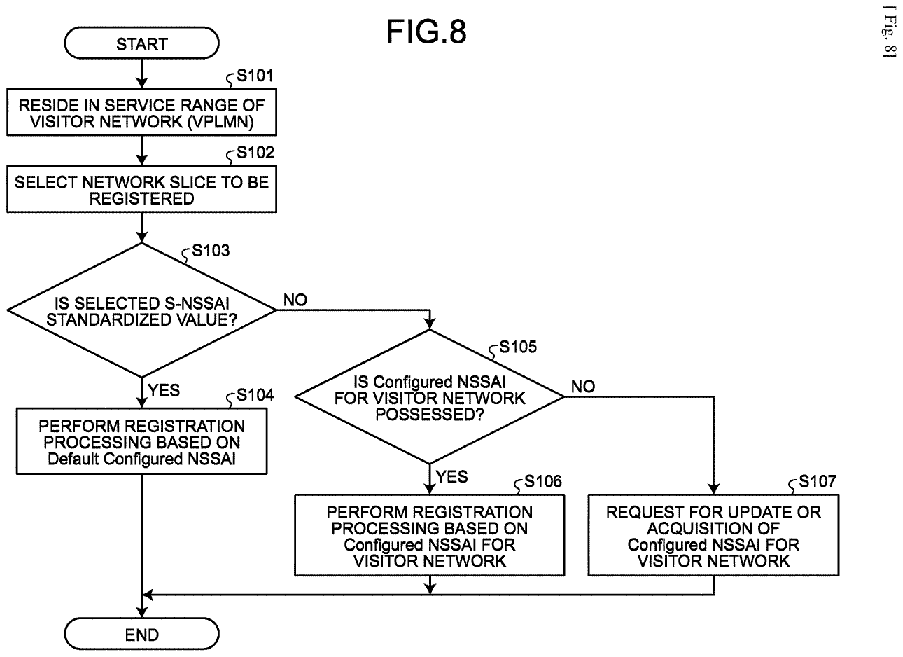

FIG. 8 is a flowchart illustrating an example of the registration processing for the visitor network according to a first embodiment.

Here, the visitor network is, for example, another communication carrier identified by the PLMN ID as the VPLMN having a roaming agreement, a local 5G provider that manages/operates the local 5G, a private network provider that manages/operates a private network, or the like.

The local 5G or the private network is also referred to as a standalone non-public network (SNPN). The local 5G or the private network is identified by a set of the PLMN ID and a network identifier (NID).

In addition, the private network may be provided in the form of a public network integrated (PNI)-non-public network (NPN). The private network is identified by the PLMN ID. In the private network, access to the network is restricted by using a closed access group (CAG).

As illustrated in FIG. 8, the UE 10 resides within a service range of the VPLMN which is the visitor network (step S101). Note that the UE 10 is a terminal device having a subscription (contract) with the HPLMN which is the home network.

The UE 10 residing in the visitor network selects the network slice to be registered based on the configured NSSAI for the HPLMN when performing registration to the visitor network via the V-RAN 20-2 serving as the serving cell (step S102).

The UE 10 confirms whether or not the S-NSSAI of the selected network slice is a standardized value (step S103).

In a case where the S-NSSAI of the selected network slice is a standardized value (step S103: Yes), the registration processing is performed based on the possessed default configured NSSAI (step S104), and the processing ends.

Here, the UE 10 transmits a registration request to the visitor network as the registration processing based on the default configured NSSAI in step S104. At this time, in a case where the S-NSSAI of the selected network slice is included in the default configured NSSAI, the UE 10 transmits the registration request by including the S-NSSAI of the selected network slice in the requested NSSAI (an example of identification information for identifying a requested slice).

On the other hand, in a case where the S-NSSAI of the selected network slice is not included in the default configured NSSAI, the UE 10 selects another S-NSSAI included in the default configured NSSAI. Then, the UE 10 transmits the registration request by including the newly selected S-NSSAI in the requested NSSAI.

In a case where the S-NSSAI of the selected network slice is not a standardized value (step S103: No), the UE 10 confirms whether or not the configured NSSAI for the visitor network is possessed (step S105).

In a case where the configured NSSAI for the visitor network is possessed (step S105: Yes), the UE 10 performs the registration processing based on the configured NSSAI for the visitor network (step S106), and ends the processing.

Here, the UE 10 transmits a registration request to the visitor network as registration processing based on the configured NSSAI for the visitor network in step S106.

At this time, the UE 10 confirms whether or not the S-NSSAI (hereinafter, also referred to as corresponding visitor S-NSSAI) of the visitor network corresponding to the S-NSSAI (hereinafter, also referred to as selected home S-NSSAI) of the home network of the selected network slice is included in the configured NSSAI.

In a case where the corresponding visitor S-NSSAI is included in the configured NSSAI, the UE 10 transmits a registration request including the requested NSSAI including the corresponding visitor S-NSSAI and mapping information regarding mapping between the corresponding visitor S-NSSAI and the selected home S-NSSAI.

On the other hand, in a case where the corresponding visitor S-NSSAI is not included in the configured NSSAI, the UE 10 selects another S-NSSAI included in the configured NSSAI. The UE 10 transmits a registration request including the requested NSSAI including the newly selected S-NSSAI and mapping information regarding mapping between the S-NSSAI of the visitor network (newly selected S-NSSAI) and the S-NSSAI of the home network corresponding to the S-NSSAI.

In a case where the configured NSSAI for the visitor network is not possessed (step S105: No), the UE 10 requests for update or acquisition of the configured NSSAI for the visitor network (step S107), and ends the processing.

### Configured NSSAI Update Request Processing

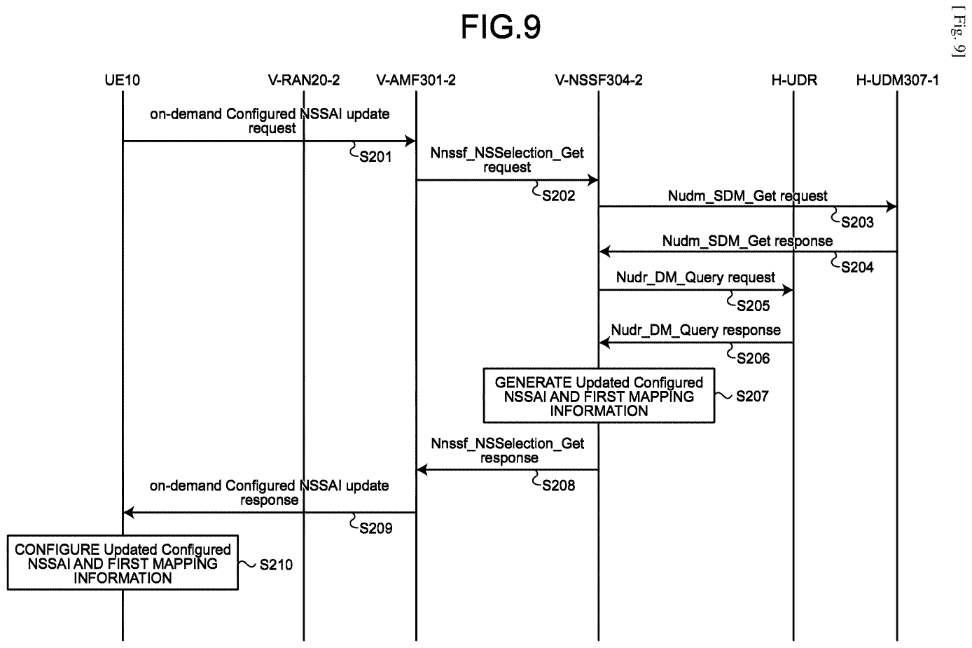

FIG. 9 is a sequence diagram illustrating an example of processing of requesting for update of the configured NSSAI for the visitor network according to the first embodiment. The processing illustrated in FIG. 9 starts when step S107 is performed in the registration processing of FIG. 8.

The UE 10, which is the terminal device, transmits an on-demand configured NSSAI update request message to the V-AMF 301-2 via the V-RAN 20-2 according to the processing of step S107 (see FIG. 8) (step S201). Note that the V-RAN 20-2 is a base station device serving as the serving cell of the UE 10.

Upon receiving the configured NSSAI update request message, the V-AMF 301-2 transmits an Nnssf_NSSelection_Get request message to the V-NSSF 304-2 via the Nnssf of the service-based interface (step S202). The Nnssf_NSSelection_Get request message is a message for requesting for an NSSelection_Get service.

Upon receiving the request for the update of the configured NSSAI in the roaming, the V-NSSF 304-2 transmits an Nudm_SDM_Get request message to an H-UDM 307-1 of the home network of the UE 10 via the Nudm of the service-based interface (step S203). The Nudm_SDM_Get request message is a message for acquiring information related to the subscribed S-NSSAI of the home network.

The V-NSSF 304-2 receives an Nudm_SDM_Get response message including the information related to the subscribed S-NSSAI in the home network of the UE 10 from the H-UDM 307-1 as a response to the Nudm_SDM_Get request message (step S204). Here, the information related to the subscribed S-NSSAI acquired by the V-NSSF 304-2 includes the non-standardized S-NSSAI value valid only in the home network.

The V-NSSF 304-2 further transmits an Nudr_DM_Query request message to the home network (H-UDR in FIG. 9) of the UE 10 via the Nudr of the service-based interface (step S205). The Nudr_DM_Query request message is a message for acquiring information related to the 5QI supported by each first S-NSSAI of the home network included in the subscribed S-NSSAI.

The V-NSSF 304-2 receives a Nudr_DM_Query response message including information related to the 5QI supported by each first S-NSSAI from the H-UDR as a response to the Nudr_DM_Query request message (step S206).

Here, in a case where an H-PCF 305-1 manages the information related to the 5QI supported by each first S-NSSAI of the home network, the V-NSSF 304-2 may request the H-PCF 305-1 for the information related to the 5QI supported by each first S-NSSAI of the home network. The V-NSSF 304-2 requests the H-PCF 305-1 by using, for example, an Npcf_SMPolicyControl service.

The V-NSSF 304-2 generates the configured NSSAI (updated configured NSSAI) for the visitor network and first mapping information (step S207). The updated configured NSSAI and the first mapping information are generated based on the acquired information related to the subscribed S-NSSAI and the information related to the 5QI supported by each first S-NSSAI of the home network included in the subscribed S-NSSAI(s). Details of the generation of the configured NSSAI and the first mapping information will be described later.

The V-NSSF 304-2 returns an Nnssf_NSSelection_Get response message to the V-AMF 301-2 as a response to the request for the NSSelection_Get service (step S208). The Nnssf_NSSelection_Get response message includes the configured NSSAI (updated configured NSSAI) for the visitor network and the first mapping information.

Upon acquiring the configured NSSAI updated for the UE 10 and the first mapping information, the V-AMF 301-2 returns a configured NSSAI update response message (on-demand configured NSSAI update response) to the UE 10 via the V-RAN 20-2 (step S209). The configured NSSAI update response message includes the configured NSSAI for the visitor network and the first mapping information.

Here, the configured NSSAI update response message includes an instruction to perform registration/re-registration processing in the visitor network in accordance with the update of the configured NSSAI for the visitor network.

Upon acquiring the configured NSSAI for the visitor network and the first mapping information via the configured NSSAI update response message, the UE 10 configures the configured NSSAI for the visitor network and the first mapping information (step S210).

### Generation Processing for Configured NSSAI for Visitor Network and First Mapping Information

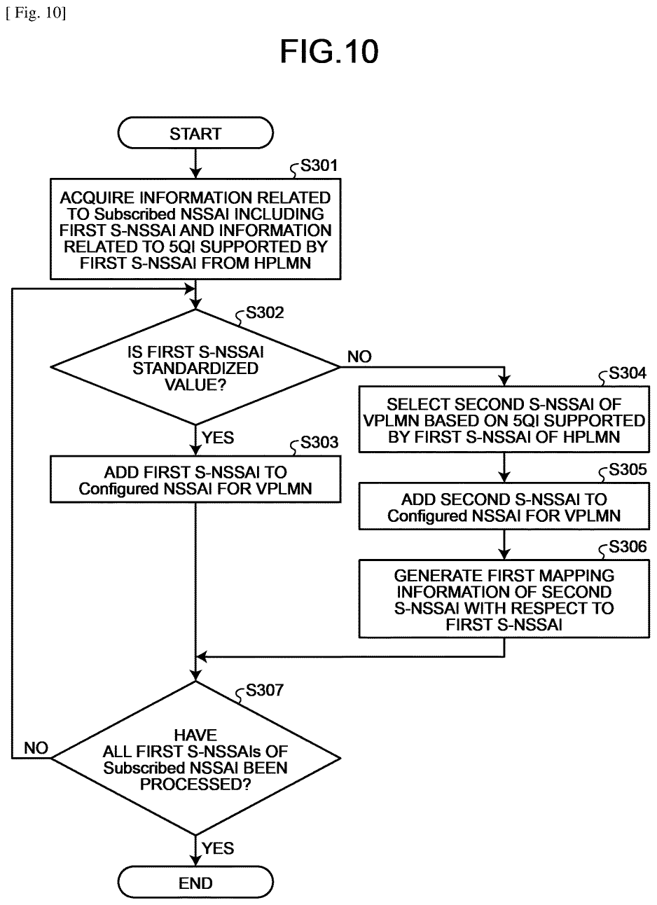

FIG. 10 is a flowchart illustrating an example of a flow of generation processing for the configured NSSAI for the visitor network and the first mapping information in the V-NSSF 304-2. The configured NSSAI is an example of identification information for identifying a configured slice configured by the visitor network.

The V-NSSF 304-2 acquires the information related to the subscribed S-NSSAI including the first S-NSSAI(s) and the information related to the 5QI supported by each first S-NSSAI from the home network (step S301). The subscribed S-NSSAI is an example of identification information (network slice selection assistance information) for identifying the requestable slice whose use is requestable by the terminal device among the first network slices provided by the home network. Furthermore, the information related to the 5QI is an example of the first quality information regarding the first communication quality supported by the requestable slice.

The V-NSSF 304-2 determines whether or not the first S-NSSAI included in the information related to the subscribed S-NSSAI is a standardized value (step S302).

In a case where the first S-NSSAI is a standardized value (step S302: Yes), the first S-NSSAI is added to the configured NSSAI for the visitor network (step S303).

On the other hand, in a case where the first S-NSSAI included in the information related to the subscribed S-NSSAI is a non-standardized value (step S302: No), the V-NSSF 304-2 selects second S-NSSAI of the visitor network (VPLMN) based on the 5QI supported by the first S-NSSAI of the home network (HPLMN) (step S304).

For example, the V-NSSF 304-2 selects the second S-NSSAI (an example of identification information for identifying the support slice) supporting the 5QI (an example of the second communication quality) corresponding to the 5QI supported by the first S-NSSAI, among the second S-NSSAIs provided by the visitor network.

The V-NSSF 304-2 adds the selected second S-NSSAI to the configured NSSAI for the visitor network (step S305). Subsequently, the V-NSSF 304-2 generates the first mapping information of the second S-NSSAI with respect to the first S-NSSAI (step S306).

The V-NSSF 304-2 determines whether or not all the first S-NSSAIs included in the information related to the subscribed S-NSSAI has been processed (step S307).

In a case where not all the first S-NSSAI(s) have been processed (step S307: No), the V-NSSF 304-2 performs the processing of step S302 and subsequent steps. On the other hand, in a case where all the first S-NSSAI(s) have been processed (step S307: Yes), the V-NSSF 304-2 ends the processing.

In step S301, in a case where the first S-NSSAI(s) is the network slice supporting the TSC QoS flow, the V-NSSF 304-2 may acquire information related to the PDU set QoS parameter from the home network in addition to or instead of the information regarding the 5QI supported by each first S-NSSAI.

Further, in step S304, the V-NSSF 304-2 may select the second S-NSSAI of the visitor network (VPLMN) based on the PDU set QoS parameter, in addition to or instead of the 5QI supported by the first S-NSSAI of the home network (HPLMN).

### Second S-NSSAI Selection Processing

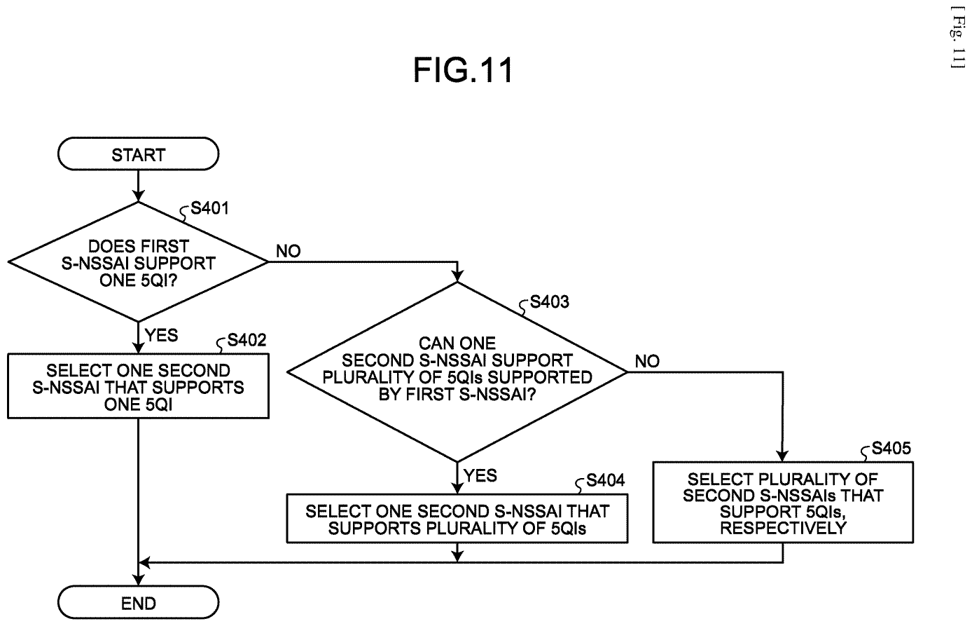

FIG. 11 is a flowchart illustrating an example of a flow of second S-NSSAI selection processing according to the first embodiment. In the selection processing, selection of the second S-NSSAI of the visitor network to be mapped to the first S-NSSAI of the home network is performed. The V-NSSF 304-2 performs the selection processing of FIG. 11 in step S304 of FIG. 10.

The V-NSSF 304-2 determines whether or not the first S-NSSAI supports one 5QI (step S401).

In a case where the first S-NSSAI of the home network supports one 5QI (step S401: Yes), the V-NSSF 304-2 selects the second S-NSSAI of the visitor network that supports one 5QI (step S402), and ends the processing.

On the other hand, in a case where the first S-NSSAI of the home network supports more than one 5QI, that is, two or more 5QIs (step S401: No), the V-NSSF 304-2 determines whether or not one second S-NSSAI can support a plurality of 5QIs supported by the first S-NSSAI (step S403).

In a case where one second S-NSSAI can support a plurality of 5QIs (step S402: Yes), the V-NSSF 304-2 selects one second S-NSSAI of the visitor network that supports a plurality of 5QIs (step S404), and ends the processing.

On the other hand, in a case where one second S-NSSAI cannot support a plurality of 5QIs (step S403: No), the V-NSSF 304-2 selects a plurality of second S-NSSAIs of the visitor network that support the 5QIs, respectively (step S405), and ends the processing.

That is, a correspondence between the first S-NSSAI of the home network and the second S-NSSAI of the visitor network may be a 1-to-N correspondence (N is an integer equal to or larger than 2) in addition to a 1-to-1 correspondence. That is, mapping information regarding mapping of a set of two or more second S-NSSAIs and the first S-NSSAI can be generated.

In step S405, in a case where there are a plurality of sets including the first S-NSSAI and a plurality of corresponding second S-NSSAIs, sets belonging to the same network slice simultaneous registration group (NSSRG) are selected.

### Generation Processing for First Mapping Information

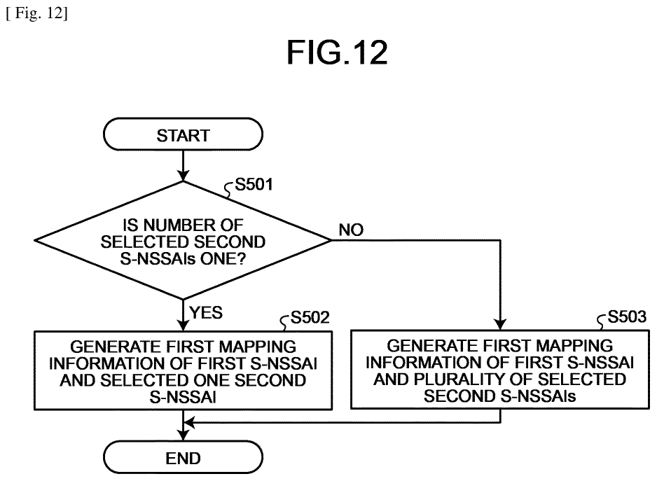

FIG. 12 is a flowchart illustrating an example of a flow of generation processing for the first mapping information according to the first embodiment. The V-NSSF 304-2 performs the generation processing of FIG. 12 in step S306 of FIG. 10.

The V-NSSF 304-2 determines whether or not the number of selected second S-NSSAIs of the selected visitor network is one (step S501).

In a case where the number of selected second S-NSSAIs of the visitor network is one (step S501: Yes), the V-NSSF 304-2 generates the first mapping information of the first S-NSSAI of the home network and the selected one second S-NSSAI (step S502).

On the other hand, in a case where the number of selected second S-NSSAIs of the visitor network is not one, that is, the number of selected second S-NSSAIs of the visitor network is two or more (step S501: No), the V-NSSF 304-2 generates the first mapping information of the first S-NSSAI of the home network and the plurality of selected second S-NSSAIs (step S503).

### Mapping Processing for Second S-NSSAI

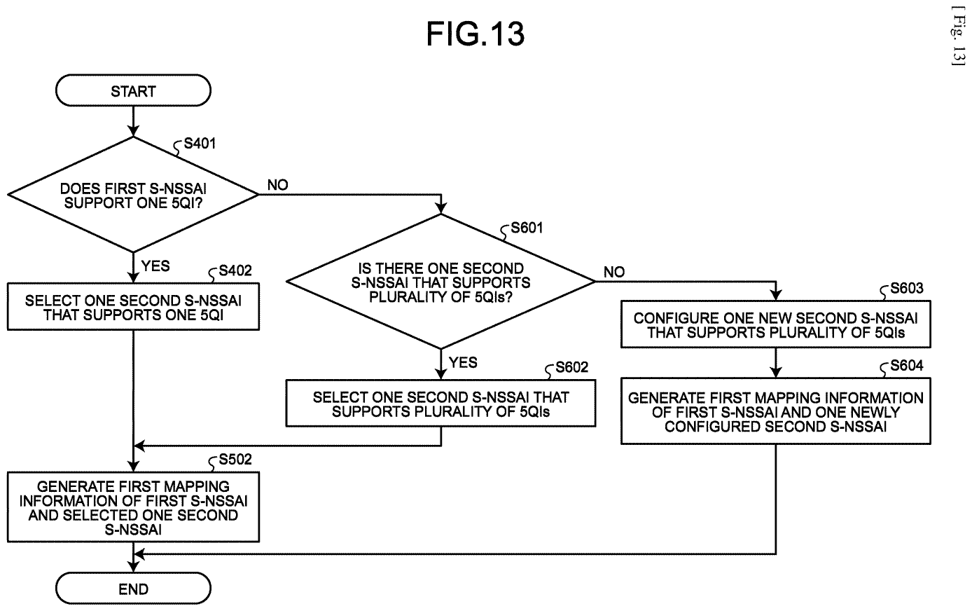

FIG. 13 is a flowchart illustrating an example of a flow of mapping processing for the second S-NSSAI according to the first embodiment. In the mapping processing, mapping of the second S-NSSAI of the visitor network to the first S-NSSAI of the home network is performed. The mapping processing is performed by the V-NSSF 304-2 instead of the processings of FIGS. 11 and 12 described above, for example. The V-NSSF 304-2 performs the mapping processing of FIG. 13 in step S304 of FIG. 10.

The same processing as those in FIGS. 11 and 12 are denoted by the same reference numerals.

The V-NSSF 304-2 determines whether or not the first S-NSSAI supports one 5QI (step S401).

In a case where the first S-NSSAI of the home network supports one 5QI (step S401: Yes), the V-NSSF 304-2 selects the second S-NSSAI of the visitor network that supports one 5QI (step S402). Thereafter, the V-NSSF 304-2 generates the first mapping information of the first S-NSSAI of the home network and the selected one second S-NSSAI (step S502), and ends the processing.

On the other hand, in a case where the first S-NSSAI supports more than one 5QI, that is, two or more 5QIs (step S401: No), the V-NSSF 304-2 determines whether or not there is one second S-NSSAI that supports two or more 5QIs (step S601).

In a case where there is one second S-NSSAI that supports two or more 5QIs (step S601: Yes), the V-NSSF 304-2 selects the one second S-NSSAI that supports two or more 5QIs (step S602), and performs the processing of step S502.

On the other hand, in a case where there is no one second S-NSSAI that supports two or more 5QIs (step S601: No), the V-NSSF 304-2 configures one new second S-NSSAI of the visitor network that supports a plurality of 5QIs (step S603).

The V-NSSF 304-2 generates the first mapping information of the first S-NSSAI of the home network and the one newly configured second S-NSSAI (step S604), and ends the processing.

That is, in the example of FIG. 13, the correspondence between the first S-NSSAI of the home network and the second S-NSSAI of the visitor network is a 1-to-1 correspondence.

### Another Example of Configured NSSAI Update Request Processing

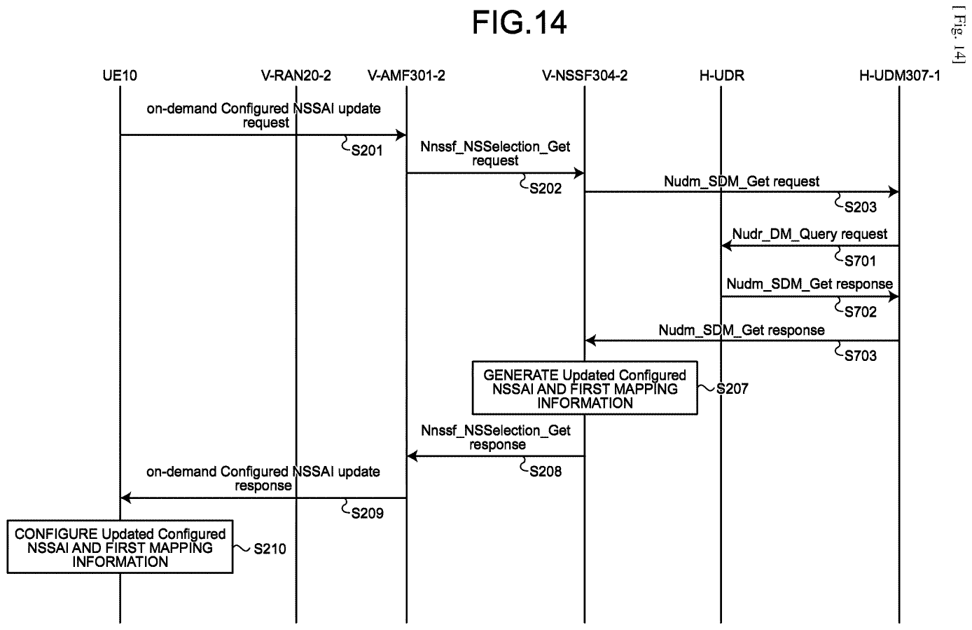

FIG. 14 is a sequence diagram illustrating another example of the processing of requesting for the update of the configured NSSAI for the visitor network according to the first embodiment. Among the processings illustrated in FIG. 14, the same processings as those illustrated in FIG. 9 are denoted by the same reference numerals, and a description thereof is omitted.

Upon receiving the Nudm_SDM_Get request message in step S203, the H-UDM 307-1 of the home network of the UE 10 transmits the Nudr_DM_Query request message to the H-UDR via the Nudr of the service-based interface (step S701). The Nudr_DM_Query request message is a message for acquiring the information related to the 5QI supported by each first S-NSSAI of the home network included in information related to the subscribed S-NSSAI.

The H-UDM 307-1 receives the Nudr_DM_Query response message including the information related to the 5QI supported by each S-NSSAI from the H-UDR as a response to the Nudr_DM_Query request message (step S702).

Here, in a case where an H-PCF 305-1 manages the information related to the 5QI supported by each first S-NSSAI of the home network, the H-UDM 307-1 may request the H-PCF 305-1 for the information related to the 5QI supported by each first S-NSSAI of the home network. The H-UDM 307-1 requests the H-PCF 305-1 by using, for example, an Npcf_SMPolicyControl service.

The V-NSSF 304-2 receives the Nudm_SDM_Get response message from the H-UDM 307-1 as a response to the Nudm_SDM_Get request message (step S703). The Nudm_SDM_Get response message includes the information related to the subscribed S-NSSAI in the home network and the information related to the 5QI supported by each first S-NSSAI included in the information related to the subscribed S-NSSAI.

### Registration/Re-registration Processing with Respect to Visitor Network

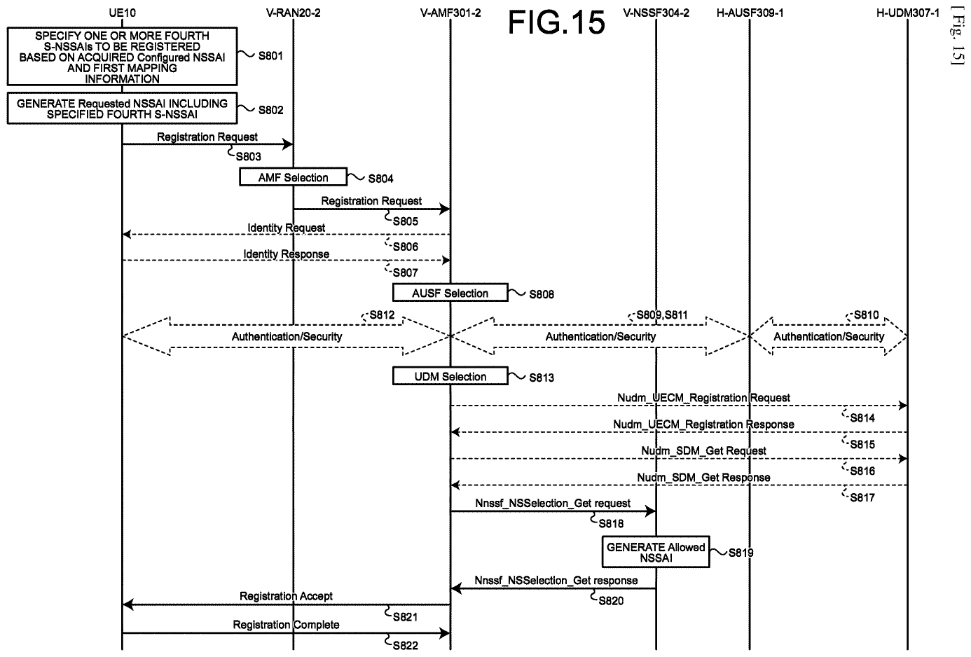

FIG. 15 is a sequence diagram illustrating an example of registration/re-registration processing with respect to the visitor network accompanying the update of the configured NSSAI according to the first embodiment. The UE 10 receives, from the V-AMF 301-2, an instruction to perform the registration/re-registration processing in the visitor network in accordance with the update of the configured NSSAI for the visitor network. The UE 10 performs the processing of FIG. 15 according to the instruction.

Before performing the registration/re-registration processing, the UE 10 selects one or more third S-NSSAI(s) to be registered from among the first S-NSSAIs of the home network included in the first mapping information.

As illustrated in FIG. 15, the UE 10 specifies one or more fourth S-NSSAI(s) (an example of requested slice information regarding the requested slice) corresponding to each selected third S-NSSAI, that is, registered in the visitor network, from among the second S-NSSAIs included in the configured NSSAI for the visitor network (step S801).

The UE 10 generates the requested NSSAI including one or more fourth S-NSSAI(s) (step S802). Here, the UE 10 generates second mapping information (an example of request mapping information) related to a correspondence between one or more fourth S-NSSAI(s) registered in the visitor network and each third S-NSSAI of the home network.

The UE 10 transmits a registration request message to the V-RAN 20-2 in order to perform registration/re-registration in the visitor network (step S803). The registration request message includes the generated requested NSSAI and the second mapping information related to the correspondence between the fourth S-NSSAI(s) of the visitor network and each third S-NSSAI of the home network included in the requested NSSAI.

Thereby, whether or not the fourth S-NSSAI(s) of the visitor network included in the requested NSSAI can be allowed based on the subscribed S-NSSAI(s) of the home network can be confirmed on the network (home network or visitor network) side.

In addition, if the UE 10 uses the default configured NSSAI, the UE 10 includes, in the registration request message, a default configured NSSAI indication. Further, the UE 10 transmits the registration request message including a UE identity.

In a case of having a valid evolved packet system (EPS) global unique temporary identifier (GUTI), the UE identity is a 5G-GUTI mapped from the EPS GUTI. Here, an evolved packet system (EPS) refers to a 4G system corresponding to long term evolution (LTE). The EPS includes an evolved-UMTS terrestrial radio access network and an evolved packet core (EPC).

The EPS GUTI is a temporary ID used to identify the UE 10 in the EPS instead of an ID uniquely assigned to each UE such as an international mobile subscriber identity (IMSI) or an international mobile equipment identity (IMEI) from the viewpoint of security.

Alternatively, the UE identity is a PLMN-specific 5G-GUTI assigned by a PLMN in which the UE 10 is attempting to register, if available.

Alternatively, the UE identity is a PLMN-specific 5G-GUTI assigned by a PLMM treated as an equivalent PLMN to the PLMN in which the UE 10 is attempting to register, if available.

Alternatively, the UE identity is a PLMN-specific 5G-GUTI assigned by any PLMN if available.

Otherwise, the UE 10 includes a subscription concealed identifier (SUCI) in the registration request message. Here, the SUCI is an ID obtained by encrypting a subscription permanent identifier (SUPI) which is an ID uniquely assigned to each UE 10.

Once the registration request message is received from the UE 10, the V-RAN 20-2 performs AMF selection (step S804).

In a case where a 5G-S-temporary mobile subscription identifier (5G-S-TMSI) or a globally unique AMF identifier (GUAMI) is not included in the registration request message, the V-RAN 20-2 selects the V-AMF301-2 based on a radio access technology ((R)AT) and, if available, the requested NSSAI.

Alternatively, in a case where the 5G-S-TMSI or GUAMI included in the registration request message does not indicate the valid V-AMF 301-2, the V-RAN 20-2 selects the V-AMF 301-2 based on the radio access technology ((R)AT) and, if available, the requested NSSAI.

In a case where the V-RAN 20-2 is an NG-RAN, the V-RAN 20-2 transfers a registration request including the selected PLMN ID (for example, the VPLMN corresponding to the visitor network) or a registration request including a set of the PLMN ID and the network identifier (NID) for identifying the standalone non-public network (SNPN) operating as the visitor network to the V-AMF 301-2 (step S805).

In a case where the UE 10 has not provided the SUCI to the V-AMF 301-2, the V-AMF 301-2 starts identity request processing and transmits an identity request message to the UE 10, thereby requesting for the SUCI (step S806).

Upon receiving the identity request message in step S806, the UE 10 transmits an identity response message including the SUCI (step S807). Here, the UE 10 can acquire the SUCI by using a public key of the HPLMN.

The V-AMF 301-2 performs AUSF selection based on the SUPI or the SUCI (step S808) and starts authentication of the UE 10.

Upon receiving a request for authentication from the V-AMF 301-2, an H-AUSF 309-1 needs to perform authentication/security of the UE 10 (step S809).

The H-AUSF 309-1 selects the H-UDM 307-1 and acquires authentication data from the H-UDM 307-1 (authentication/security) as authentication processing (step S810).

When the UE 10 is authenticated, the H-AUSF 309-1 provides information regarding security to the V-AMF 301-2 (authentication/security) (step S811).

Upon successful authentication of the UE 10, the V-AMF 301-2 starts NG application protocol (NGAP) processing to provide a security context to the V-RAN 20-2. The V-RAN 20-2 holds the security context and transmits a response to the V-AMF 301-2. Hereinafter, the V-RAN 20-2 uses the security context to protect messages exchanged with the UE 10 (authentication/security) (step S812).

The V-AMF 301-2 performs UDM selection based on the SUPI and selects the H-UDM 307-1 (step S813).

The V-AMF 301-2 transmits a Nudm_UECM_Registration Request to the H-UDM 307-1 (step S814), and receives a Nudm_UECM_Registration Response from the H-UDM 307-1 (step S815). The V-AMF 301-2 is registered in the H-UDM 307-1 by using an Nudm_UECM_Registration service.

In a case where the V-AMF 301-2 does not have subscription data of the UE 10, the V-AMF 301-2 transmits a Nudm_SDM_Get Request to the H-UDM 307-1 (step S816). The V-AMF 301-2 receives a Nudm_SDM_Get Response from the H-UDM 307-1 (step S817).

The V-AMF 301-2 acquires the subscription data such as access and mobility subscription data, SMF selection subscription data, or the like, from the H-UDM 307-1 by using an Nudm_SDM_Get service.

Here, the subscription data includes slice selection subscription data. Here, the slice selection subscription data is, for example, information related to the subscribed S-NSSAI.

The V-AMF 301-2 confirms a use contract of each fourth S-NSSAI of the requested NSSAI from the second mapping information related to the correspondence between the fourth S-NSSAI(s) included in the requested NSSAI and each third S-NSSAI of the home network and the slice selection subscription data.

The V-AMF 301-2 transmits an Nnssf_NSSelection_Get request message including each fourth S-NSSAI of the requested NSSAI to the V-NSSF 304-2 (step S818). Here, the Nnssf_NSSelection_Get request message includes the fourth S-NSSAI(s) corresponding to each third S-NSSAI of the home network having the usage contract.

The V-NSSF 304-2 confirms whether or not each fourth S-NSSAI of the requested NSSAI can be supported in an area (registration area) in which the UE 10 is registered. The V-NSSF 304-2 generates the allowed NSSAI (an example of allowed slice information regarding an allowed slice) including a supportable fifth S-NSSAI(s) from the fourth S-NSSAI(s) (step S819). That is, the V-NSSF 304-2 selects the fifth S-NSSAI(s) allowed to be used for the UE 10 residing in the visitor network, and generates the allowed NSSAI including the fifth S-NSSAI(s).

In addition, the V-NSSF 304-2 configures each sixth S-NSSAI that is not supportable in the area in which the UE 10 is registered, in other words, that is not allowed to be used among the fourth S-NSSAI(s), in the rejected S-NSSAI (an example of slice information regarding a rejected slice).

The V-NSSF 304-2 may determine the allowed NSSAI and the rejected S-NSSAI in units of mobility management areas such as the tracking area.

In this case, the registration area includes one or more tracking areas. Each S-NSSAI of the allowed NSSAI is treated as a network slice available in all tracking areas in the registration area. On the other hand, a network slice that is not supported in at least one tracking area in the registration area is treated as the rejected S-NSSAI.

As a response to the Nnssf_NSSelection_Get request message, the V-NSSF 304-2 returns, to the V-AMF 301-2, the Nnssf_NSSelection_Get response message including the allowed NSSAI and the rejected S-NSSAI(s) if there is a rejected sixth S-NSSAI(s) (step S820).

As described above, the V-AMF 301-2 may determine the target NSSAI by itself or in cooperation with the V-NSSF 304-2. The target NSSAI may include the third S-NSSAI of the home network. As a result, the UE 10 can be redirected to cells and tracking areas of other frequency bands that support the third S-NSSAI of the home network, and other tracking areas.

Furthermore, the V-NSSF 304-2 may include information regarding a data network name (DNN) corresponding to each fifth S-NSSAI in the Nnssf_NSSelection_Get response message in order to provide, to the UE 10, the information regarding the DNN to be used for each fifth S-NSSAI of the allowed NSSAI. That is, the V-NSSF 304-2 assigns the DNN to be used for each fifth S-NSSAI of the allowed NSSAI.

Here, the DNN corresponds to an access point name (APN) used in a system prior to 4G. The DNN/APN specifies a data network (DN)/access point (AP) which is a device serving as a gateway.

The V-AMF 301-2 returns a registration accept message including the allowed NSSAI to the UE 10 as a response to the registration request message (step S821).

The UE 10 treats each fourth S-NSSAI that is included in the requested NSSAI and is not included in the allowed NSSAI as the rejected S-NSSAI. That is, the V-AMF 301-2 does not need to explicitly provide information regarding the rejected sixth S-NSSAI to the UE 10.

Furthermore, for the UE 10 that supports the partial network slice, the registration accept message may include the partially allowed NSSAI or S-NSSAI rejected partially in the registration area. A list of tracking areas in which the S-NSSAI is supported is provided for each S-NSSAI of the partially allowed NSSAI. A list of tracking areas in which the S-NSSAI is supported or not supported is provided for each S-NSSAI of the partially rejected S-NSSAI(s).

If an area of service (AoS) of the third S-NSSAI(s) of the home network is included in the registration area of the visitor network, the V-AMF 301-2 includes the third S-NSSAI(s) of the home network in the partially allowed NSSAI as the partial network slice. Alternatively, the V-AMF 301-2 may provide the third S-NSSAI(s) of the home network as the S-NSSAI rejected partially in the registration area. Here, in a case where a boundary of the AoS of the third S-NSSAI(s) does not coincide with a boundary of the tracking area, the network slice location availability information is provided to the UE 10 instead of the list of the tracking areas.

Upon receiving the registration accept message, the UE 10 returns a registration complete message to the V-AMF 301-2 as a response to the registration accept message, and the registration processing is completed (step S822).

With the above processing, the UE 10 can request for the establishment of the PDU session for one or more fifth S-NSSAI(s) included in the allowed NSSAI and the DNN corresponding to each fifth S-NSSAI in the registration area of the visitor network. The UE 10 may transmit a PDU session establishment request including the fifth S-NSSAI and DNN information regarding the DNN to the base station 20 of the visitor network.

Here, in a case of using a plurality of fifth S-NSSAIs of the visitor network to support one third S-NSSAI of the home network, the UE 10 establishes the PDU session for each set of the fifth S-NSSAI and the DNN.

For example, in a case where different DNNs are assigned to two fifth S-NSSAIs, the UE 10 requests for establishment of a first session and a second session. The first session is a session by one of the two fifth S-NSSAIs and the DNN assigned to the one fifth S-NSSAI. The second session is a session by the other one of the two fifth S-NSSAIs and the DNN assigned to the other fifth S-NSSAI.

Furthermore, in a case where two or more fifth S-NSSAIs can be supported by the same DNN, the UE 10 can include an instruction to process two or more fifth S-NSSAIs that can be supported by the same DNN in the same session in a session establishment request. The SMF 306 establishes one PDU session for the two or more fifth S-NSSAIs according to the instruction.

Although FIG. 15 illustrates an example of registration in the visitor network, the present technology of configuring a correspondence between the network slices of the home network and the visitor network by using the 5QI is not limited to this example.

For example, the present technology can also be applied to a case of providing the fourth S-NSSAI of the visitor network corresponding to the third S-NSSAI of the home network as the partial network slice when registering the UE 10 in the home network.

For example, an H-AMF 301-1 may include the fourth S-NSSAI(s) of the visitor network in the partially allowed NSSAI. The H-AMF 301-1 may perform the processing of FIGS. 11 to 13 to generate mapping information of the third S-NSSAI of the home network and the fourth S-NSSAI(s) of the visitor network included in the partially allowed NSSAI. The mapping information is provided to the UE 10 together with the partially allowed NSSAI.

Similarly, the H-AMF 301-1 can configure the fourth S-NSSAI(s) of the visitor network as the S-NSSAI rejected partially in the registration area. The H-AMF 301-1 may perform the processing of FIGS. 11 to 13 to generate mapping information to be provided to the UE 10, the mapping information being mapping information of the third S-NSSAI of the home network and the fourth S-NSSAI(s) of the visitor network as the partially rejected S-NSSAI.

Further, the H-AMF 301-1 may include the fourth S-NSSAI(s) of the visitor network in the target NSSAI. The H-AMF 301-1 may apply the processing of FIGS. 11 to 13 to generate mapping information of the third S-NSSAI of the home network and the fourth S-NSSAI(s) of the visitor network included in the target NSSAI. The mapping information is provided to the UE 10 together with the target NSSAI.

Further, the H-AMF 301-1 acquires the RAT/frequency selection priority index (RFSP index) for the fourth S-NSSAI(s) of the visitor network included in the target NSSAI, and transmits the RFSP index to the H-RAN 20-1. The RFSP index is an example of priority information regarding a priority for frequency selection for the fourth S-NSSAI(s).

The H-RAN 20-1 configures a parameter related to cell reselection in the UE 10 according to the acquired RFSP index for the fourth S-NSSAI(s) of the visitor network. The parameter related to the cell reselection is a parameter for redirecting the UE 10 to a cell providing the fourth S-NSSAI(s).

According to the first embodiment, the NF of the visitor network can acquire information related to the type of the 5QI supported by the network slice in the visitor network that dynamically supports the roaming. As a result, the UE 10 can also use the non-standardized network slice used in the home network in the visitor network.

### 5. Second Embodiment

For example, the network slice provided by the home network may support a plurality of QoS flows to support the multimodal application that handles a plurality of types of data like the XR. However, it is assumed that the QoS cannot be satisfied for the network slice that supports a plurality of QoS flows. In this case, the use of all the network slice is limited.

In such a case, for example, a network slice that cannot satisfy at least one QoS flow can be used by complementing with the network slice of the visitor network.

Therefore, in the second embodiment, the network slice of the home network that does not satisfy the QoS is complemented with the network slice of the visitor network. As a result, the UE 10 can use more network slices.

More specifically, the information processing device 300 according to the second embodiment includes the control unit 33 that receives a registration request including requested slice information, mapping information, and a complementation request from the terminal device 10.

The requested slice information is information regarding the requested slice that the terminal device 10 requests to use among the first network slices provided by the home network. The mapping information is information regarding a correspondence between the requested slice and the support slice that supports the second communication quality corresponding to one or more first communication qualities that can be supported by the requested slice among the second network slices provided by the visitor network. The complementation request is an indication requesting to complement the requested slice with the support slice.

Upon receiving the registration request, the control unit 33 acquires, from the home network, requestable slice information regarding a requestable slice whose use is requestable by the terminal device 10 among the first network slices.

In a case where the support slice can support a third communication quality corresponding to the first communication quality that is not supported by the requested slice, the control unit 33 configures the requested slice as a conditional allowed slice.

As a result, the information processing device 300 can complement the first communication quality that is not supported by the requested slice with the support slice.

### 5-1. First Example

First, a case where the network slice is complemented according to a request from the UE 10 will be described.

The UE 10 performs registration processing in the home network based on the configured NSSAI for the home network. The UE 10 generates the requested NSSAI including one or more first S-NSSAI(s) from the configured NSSAI. The UE 10 transmits a registration request message including the requested NSSAI to the H-AMF 301-1 of the home network.

The UE 10 acquires the allowed NSSAI from the H-AMF 301-1 as a response to the registration request message. The allowed NSSAI includes, for the UE 10 of the home network, one or more third S-NSSAI(s) allowed to be used in the registration area. The third S-NSSAI(s) is S-NSSAI(s) in the requested NSSAI.

As a result, the UE 10 is registered in the home network.

It is assumed that one third S-NSSAI included in the allowed NSSAI (first allowed NSSAI) is, for example, information for identifying a network slice that supports two or more 5QIs. Furthermore, for example, the home network may restrict the use of one 5QI for the reason of access control in the registration area. In this case, the home network updates the allowed NSSAI (first allowed NSSAI) with new allowed NSSAI (second allowed NSSAI). The second allowed NSSAI is allowed NSSAI in which the third S-NSSAI that supports one 5QI whose use is restricted is deleted from the first allowed NSSAI.

The UE 10 treats the deleted third S-NSSAI as rejected S-NSSAI.

In a case where the UE 10 wants to use one third S-NSSAI deleted from the first allowed NSSAI, the UE may request, according to the processing of FIG. 15, the visitor network to register the fourth S-NSSAI corresponding to the one third S-NSSAI by using the configured NSSAI for the visitor network.

Alternatively, the UE 10 may request the home network to register one third S-NSSAI in such a way that the home network can support the 5QI whose use is not restricted and the visitor network can support one 5QI whose use is restricted. These 5QIs are two or more 5QIs that support one third S-NSSAI.

That is, a communication system according to the second embodiment complements the third S-NSSAI of the home network with the fourth S-NSSAI of the visitor network.

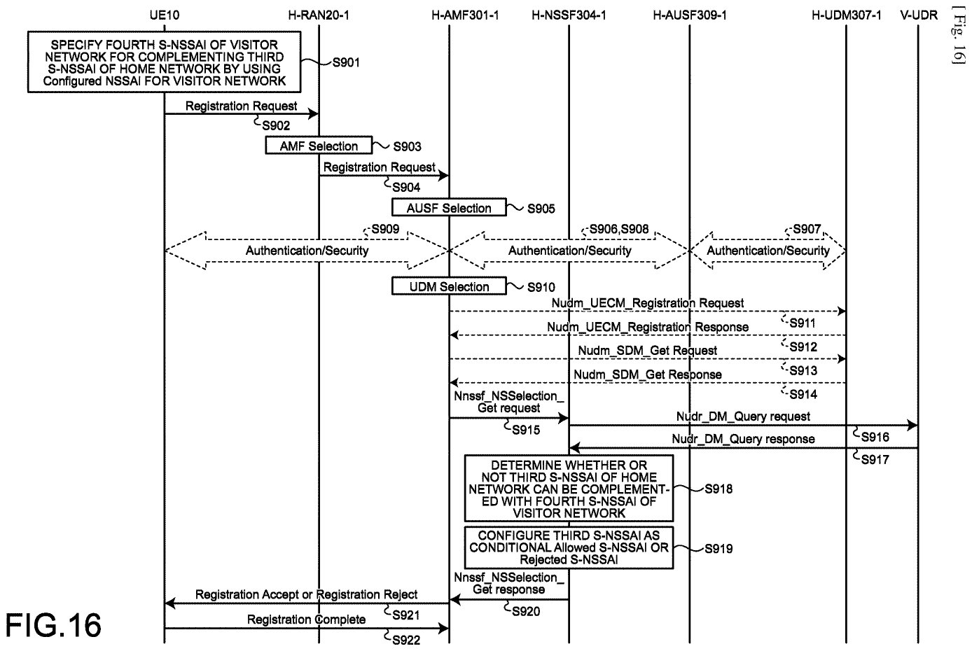

FIG. 16 is a sequence diagram illustrating an example of registration processing for complementing the S-NSSAI of the home network with the visitor network.

The UE 10 specifies the fourth S-NSSAI of the visitor network for complementing the third S-NSSAI of the home network by using the configured NSSAI for the visitor network (step S901).

The UE 10 transmits, to the H-RAN 20-1, a registration request message including the requested NSSAI including the third S-NSSAI, third mapping information (an example of complementary mapping information) related to a correspondence between the third S-NSSAI and one or more fourth S-NSSAI(s) (identification information for identifying the support slice), and a complementation indication (step S902). The complementation indication indicates to complement the third S-NSSAI of the home network.

Once the registration request message is received from the UE 10, the H-RAN 20-1 performs the AMF selection (step S903). The H-RAN 20-1 transfers the received registration request to the selected H-AMF 301-1 (step S904).

The H-AMF 301-1 performs the AUSF selection based on the SUPI or the SUCI (step S905) and starts authentication of the UE 10.

Upon receiving a request for authentication from the H-AMF 301-1, the H-AUSF 309-1 needs to perform authentication/security of the UE 10 (step S906).

The H-AUSF 309-1 selects the H-UDM 307-1 and acquires authentication data from the H-UDM 307-1 (authentication/security) as authentication processing (step S907).

When the UE 10 is authenticated, the H-AUSF 309-1 provides information regarding security to the H-AMF 301-1 (authentication/security) (step S908).

Upon successful authentication of the UE 10, the H-AMF 301-1 starts NG application protocol (NGAP) processing to provide a security context to the H-RAN 20-1.

The H-RAN 20-1 holds the security context and transmits a response to the H-AMF 301-1. Hereinafter, the H-RAN 20-1 uses the security context to protect messages exchanged with the UE 10 (authentication/security) (step S909).

The H-AMF 301-1 performs the UDM selection based on the SUPI (step S910) and selects the H-UDM 307-1.

The H-AMF 301-1 transmits the Nudm_UECM_Registration Request to the H-UDM 307-1 (step S911), and receives the Nudm_UECM_Registration Response from the H-UDM 307-1 (step S912). The H-AMF 301-1 is registered in the H-UDM 307-1 by using the Nudm_UECM_Registration service (Nudm_UECM_Registration Request/Response).

In a case where the H-AMF 301-1 does not have the subscription data of the UE 10, the H-AMF 301-1 transmits the Nudm_SDM_Get Request (step S913), and receives the Nudm_SDM_Get Response from the H-UDM 307-1 (step S914). The H-AMF 301-1 acquires the subscription data such as the access and mobility subscription data, the SMF selection subscription data, or the like, from the H-UDM 307-1 by using the Nudm_SDM_Get service (Nudm_SDM_Get/Nudm_SDM_Get Response).

Here, the subscription data includes slice selection subscription data. Here, the slice selection subscription data is, for example, information related to the subscribed S-NSSAI.

The H-AMF 301-1 confirms a use contract of the third S-NSSAI of the requested NSSAI from the third S-NSSAI included in the requested NSSAI and the slice selection subscription data. The H-AMF 301-1 confirms whether or not the third S-NSSAI is subscribed S-NSSAI whose use is requestable by the UE 10. For example, the H-AMF 301-1 acquires information regarding the subscribed S-NSSAI from the home network, thereby confirming the use contract of the third S-NSSAI.

The H-AMF 301-1 transmits the Nnssf_NSSelection_Get request message to the H-NSSF 304-1 (step S915). The Nnssf_NSSelection_Get request message includes the requested NSSAI including the third S-NSSAI, the third mapping information related to the correspondence between the third S-NSSAI and one or more fourth S-NSSAI(s), and the complementation indication for complementing the third S-NSSAI with the visitor network.

The H-NSSF 304-1 transmits the Nudr_DM_Query request message to a V-UDR (not illustrated) of the visitor network of the UE 10 via the Nudr of the service-based interface (step S916). The Nudr_DM_Query request message is a message for acquiring information related to the 5QI supported by one or more fourth S-NSSAI(s) corresponding to the third S-NSSAI.

The H-NSSF 304-1 receives the Nudr_DM_Query response message including information related to the 5QI supported by each fourth S-NSSAI from the V-UDR as a response to the Nudr_DM_Query request message (step S917).

Here, in a case where a V-PCF 305-2 manages the information related to the 5QI supported by the fourth S-NSSAI of the visitor network, the H-NSSF 304-1 may request the V-PCF 305-2 for the information related to the 5QI supported by the fourth S-NSSAI of the visitor network. The H-NSSF 304-1 requests the V-PCF 305-2 by using, for example, the Npcf_SMPolicyControl service.

The H-NSSF 304-1 determines whether or not the fourth S-NSSAI of the visitor network can support one 5QI whose use is restricted among two or more 5QIs supported by the third S-NSSAI of the home network (step S918). The H-NSSF 304-1 performs the determination based on the acquired information related to the 5QI supported by each fourth S-NSSAI according to the complementation indication.

The H-NSSF 304-1 configures the third S-NSSAI as conditional allowed S-NSSAI or rejected S-NSSAI in response to the determination (step S919).

In a case where it is determined that the third S-NSSAI of the home network can be complemented with the fourth S-NSSAI of the visitor network, the H-NSSF 304-1 configures the third S-NSSAI as the conditional allowed S-NSSAI.

Here, the condition is that the UE 10 resides in the area of service (AoS) of the fourth S-NSSAI of the visitor network, and complements the third S-NSSAI with the fourth S-NSSAI of the visitor network. That is, the conditional allowed S-NSSAI is treated as S-NSSAI allowed to be used in the AoS of the fourth S-NSSAI.

Alternatively, in a case where it is determined that the third S-NSSAI of the home network cannot be complemented with the fourth S-NSSAI of the visitor network, the H-NSSF 304-1 configures the third S-NSSAI as the rejected S-NSSAI.

Here, the AS may include one or more tracking areas of the visitor network. The tracking area of the visitor network may be managed independently of the tracking area of the home network.

Alternatively, the AoS may be a region defined with finer granularity than the tracking area. In this case, the AOS is, for example, a region defined by a coordinate system such as latitude and longitude, a cell ID, a set of cell IDs, a base station ID, a set of base station IDs, or the like.

Information regarding the AOS is provided to the UE 10 as the network slice location availability information (S-NSSAI location availability information).

The H-NSSF 304-1 returns the Nnssf_NSSelection_Get response message as a response to the Nnssf_NSSelection_Get request message (step S920). The Nnssf_NSSelection_Get response message includes the conditional allowed S-NSSAI or rejected S-NSSAI.

The H-AMF 301-1 returns the registration accept message or a registration reject message to the UE 10 as a response to the registration request message (step S921). The registration accept message includes the conditional allowed NSSAI. The registration reject message may include the rejected S-NSSAI, and in a case where the registration reject message does not include the rejected S-NSSAI, the UE 10 treats the third S-NSSAI included in the requested NSSAI as the rejected S-NSSAI.

Upon receiving the registration accept message, the UE 10 returns the registration complete message to the H-AMF 301-1 as a response to the registration accept message (step S922), and the registration processing is completed.

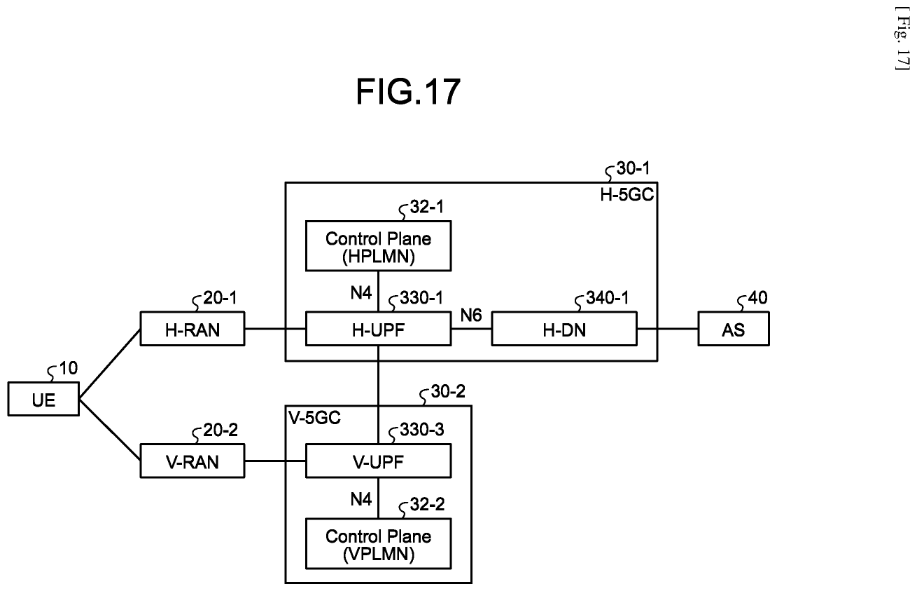

FIG. 17 is a diagram illustrating an example of an architecture of the communication system according to the second embodiment. The communication system according to the second embodiment complements the third S-NSSAI of the home network with the visitor network.

When the registration processing for the conditional allowed S-NSSAI in the home network is completed according to the processing illustrated in FIG. 16, the UE 10 may request the home network to establish a session for the conditional allowed S-NSSAI when the condition is satisfied.

Here, the conditional allowed S-NSSAI is treated as the S-NSSAI allowed to be used in the area of service (AoS) of the fourth S-NSSAI.

For example, the UE 10 resides in the AoS of the fourth S-NSSAI of the visitor network and requests for establishment of a session with the home network including the visitor network via dual connectivity. The dual connectivity includes first connection to the H-RAN 20-1 and second connection to the V-RAN 20-2.

Here, the AoS may include one or more tracking areas of the visitor network. The tracking area of the visitor network may be managed independently of the tracking area of the home network.

Alternatively, the AoS may be a region defined with finer granularity than the tracking area. In this case, the AOS is, for example, a region defined by a coordinate system such as latitude and longitude, a cell ID, a set of cell IDs, a base station ID, a set of base station IDs, or the like. Information regarding the AOS is provided to the UE 10 as the network slice location availability information.

The UE 10 establishes a first PDU session with an H-DN 340-1 via the H-RAN 20-1 and the H-UPF 330-1 as a session belonging to the DNN corresponding to the third S-NSSAI of the home network and the H-DN 340-1.

Further, the H-5GC 30-1 instructs the UE 10 or the V-RAN 20-2 to update the session according to the complementation indication. The session update instruction is an instruction to add, to the first PDU session, connection via the home network (home routed) between the UE 10 and the H-UPF 330-1 via the V-RAN 20-2 and the V-UPF 330-2 by dual connectivity.

At this time, the H-RAN 20-1 notifies the UE 10 of information for identifying the established first PDU session. Alternatively, the H-AMF 301-1 of the H-5GC 30-1 notifies the V-RAN 20-2 of information for identifying the established first PDU session.

In this session management, the H-UPF 330-1 operates as a PDU session anchor (PSA) UPF for the first PDU session. The H-UPF 330-1 controls a QoS flow (an example of a first QoS flow) of the 5QI (an example of the first communication quality) supported by the third S-NSSAI of the home network to be transmitted to the UE 10 or received from the UE 10 via the H-RAN 20-1. The H-UPF 330-1 performs control to transmit a QoS flow (an example of a second QoS flow) of the 5QI (an example of the third communication quality) supported by the fourth S-NSSAI of the visitor network, which is the fourth S-NSSAI complementing the third S-NSSAI, to the UE 10 via the V-RAN 20-2 or to receive the QoS flow from the UE 10.

Here, as illustrated in FIG. 5, a control plane 32-1 of the H-5GC 30-1 and a control plane 32-2 of the V-5GC 30-2 are connected via the security edge protection proxy (SEPP) (not illustrated in FIG. 17).

The home SEPP (hSEPP) 31-1 of the control plane 32-1 of the H-5GC 30-1 and the visitor SEPP (vSEPP) 32-2 of the control plane 32-2 of the V-5GC 30-2 are connected via the reference point N32.

FIG. 16 illustrates an example in which the conditional allowed S-NSSAI is configured in step S919, but the present technology is not limited to this example.

For example, the H-AMF 301-1 may include the fourth S-NSSAI of the visitor network in the partially allowed NSSAI in the registration area of the home network. The H-AMF 301-1 may provide, to the UE 10, the AoS of the fourth S-NSSAI and complementation information as assistance/supplementary information for the partially allowed NSSAI. The complementation indication indicates complementation of the third S-NSSAI of the home network with the fourth S-NSSAI of the visitor network.

The partially allowed NSSAI here corresponds to the conditional allowed S-NSSAI in which the third S-NSSAI of the home network is a partial network slice, and that the partial network slice is complemented with the fourth S-NSSAI of the visitor network.

Similarly, the H-AMF 301-1 configures the third S-NSSAI of the home network as the S-NSSAI rejected partially in the registration area. The H-AMF 301-1 may provide the complementation information and the AoS of the fourth S-NSSAI to the UE 10 as assistance/supplementary information for the partially rejected S-NSSAI (the third S-NSSAI of the home network). The complementation indication indicates complementation of the third S-NSSAI of the home network with the fourth S-NSSAI of the visitor network.

Furthermore, in the above description, an example has been described in which, in a case where the home network restricts the use of one 5QI by the access control in the registration area, the third S-NSSAI that supports the one 5QI is updated with new allowed NSSAI obtained by deleting the third S-NSSAI from the first allowed NSSAI. However, the present technology is not limited to this example.

For example, the home network may use the alternative S-NSSAI and assistance/ supplementary information therefor instead of updating with new allowed NSSAI. The home network may provide one or more fourth S-NSSAI(s) of the visitor network that complement the third S-NSSAI and the complementation indication to the UE 10. The complementation indication indicates complementation of the third S-NSSAI of the home network with the fourth S-NSSAI of the visitor network.

### 5-2. Second Example

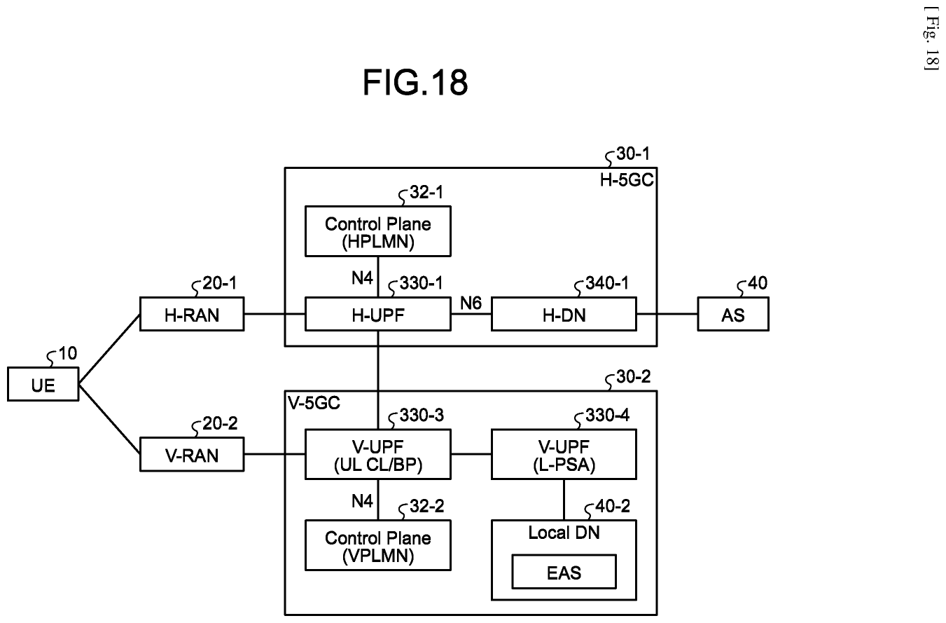

FIG. 18 is a diagram illustrating another example of the architecture of the communication system according to the second embodiment. The communication system illustrated in FIG. 18 complements the S-NSSAI of the home network with the visitor network.

The UE 10 performs the registration processing in the home network for the conditional allowed S-NSSAI, the partially allowed NSSAI, or the S-NSSAI partially rejected in the registration area according to the processing illustrated in FIG. 16. After completing the registration processing, the UE 10 resides in the area of service (AoS) of the fourth S-NSSAI of the visitor network, and establishes a session with the home network including the visitor network via the dual connectivity illustrated in FIG. 18.

Here, the AoS may include one or more tracking areas of the visitor network. The tracking area of the visitor network may be managed independently of the tracking area of the home network.

Alternatively, the AoS may be a region defined with finer granularity than the tracking area. In this case, the AOS is, for example, a region defined by a coordinate system such as latitude and longitude, a cell ID, a set of cell IDs, a base station ID, a set of base station IDs, or the like. Information regarding the AOS is provided to the UE 10 as the network slice location availability information.

Assume that the 5QI supported by the fourth S-NSSAI of the visitor network is, for example, the TSC QoS flow whose resource type is the delay-critical GBR. In this case, the visitor network selects connection to an edge application server (EAS) by session breakout.

The visitor network selects, as the V-UPF 330-2, a V-UPF 330-3 that supports a function of an uplink classifier (UL CL)/branching point (BP). Alternatively, the visitor network adds a function of the UL CL/BP to operate as the V-UPF 330-3.

The V-UPF 330-3 is connected to a local DN 40-2 via a V-UPF 330-4 by using a local breakout technique in order to be connected to the edge application server. The V-UPF 330-4 is a PDU session anchor (PSA) UPF in the visitor network.

Here, the local breakout is a method of causing the UE 10 to branch in the middle of one path (for example, the PDU session) for the H-DN 340-1 in such a way that a path with the edge application server or a delay is minimized as much as possible.

The local breakout can be achieved for one PDU session with the H-UPF 330-1 via the V-UPF 330-3 supporting the UL CL or BP.

By applying the local breakout, a function of distributing an uplink data transfer destination to the application server 40 and the edge application server connected to the local DN 40-2 is added to the PDU session. The distribution can be performed by the V-UPF 330-3 determining the type of uplink data. A method of determining the uplink data is configured by the H-SMF 306-1 via the V-SMF 306-2.

The edge application server is logically connected to a local DN 40-2. The edge application server may be implemented in the same device that physically operates as the local DN 40-2.

One S-NSSAI and one DNN are associated with one PDU session. Therefore, the local DN 40-2 is managed by the same DNN as the H-DN 340-1. That is, the H-DN 40-1 is managed as a central part of the DNN. The local DN 40-2 is managed as a local part of the DNN.

For example, one PDU session (the above-described first PDU session) associated with a first data network access identifier (DNAI) is further associated with a second data network access identifier that identifies connection to the local DN 40-2. The first data network access identifier is an identifier that identifies connection to the H-DN 340-1 corresponding to the DNN.

For example, a list of data network access identifiers is managed for one PDU session. The list of data network access identifiers includes the first data network access identifier for the H-DN 340-1 and the second data network access identifier for the local DN 40-2.

### 5-3. Third Example

In the first example described above, the UE 10 instructs complementation by the network slice of the visitor network, but here, the NF of the home network determines complementation by the visitor network.

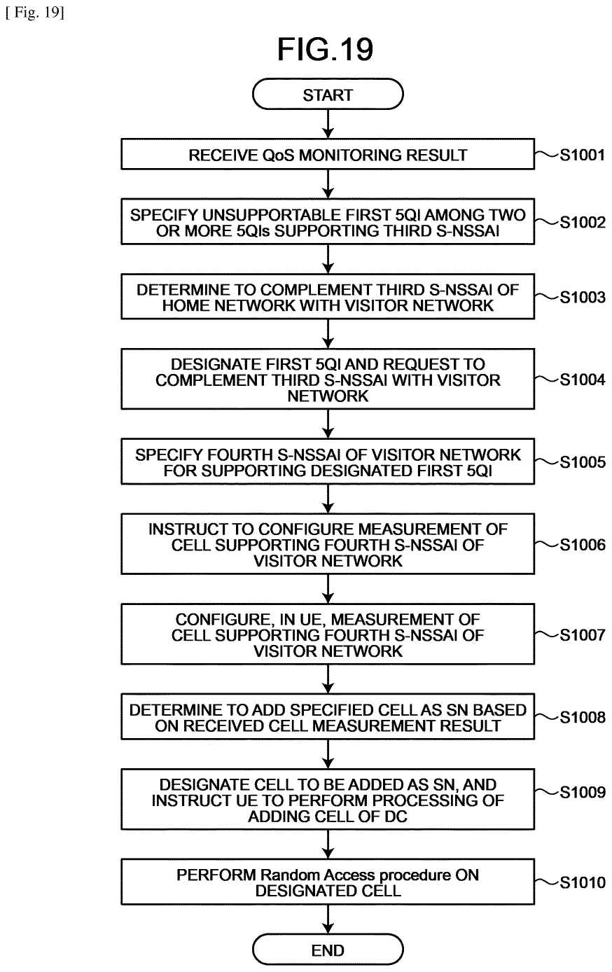

FIG. 19 is a diagram illustrating an example of processing for complementing the S-NSSAI of the home network with the visitor network according to the second embodiment.

The UE 10 establishes a session in the home network to use the one third S-NSSAI included in the allowed NSSAI (first allowed NSSAI). Here, the third S-NSSAI is information for identifying a network slice supporting two or more 5QIs.

The H-SMF 306-1 of the home network receives a QoS monitoring result from the H-UPF 330-1 (step S1001). The H-SMF 306-1 identifies an unsupportable first 5QI among two or more 5QIs supporting the third S-NSSAI (step S1002). Here, the unsupportable first 5QI is a 5QI whose use is restricted by the access control.

The H-SMF 306-1 of the home network determines to complement the third S-NSSAI of the home network with the visitor network to continue the service via the session established with the UE 10 in the connected mode (step S1003).

The H-SMF 306-1 designates the first 5QI and requests the H-NSSF 304-1 to complement the third S-NSSAI with the visitor network (step S1004).

Upon receiving the request, the H-NSSF 304-1 specifies the fourth S-NSSAI for supporting the designated first 5QI from among the second S-NSSAIs included in the configured NSSAI for the visitor network (step S1005).

Here, in a case where there are a plurality of candidates of the visitor network for the UE 10, the H-NSSF 304-1 may further narrow down the candidates of the visitor network based on the location of the UE 10 and the AoS of the visitor network. The H-NSSF 304-1 can acquire information related to the location of the UE 10 by inquiring an H-LMF 311-1.

The H-SMF 306-1 acquires information related to the specified fourth S-NSSAI of the visitor network from the H-NSSF 304-1 as a response to the inquiry. The H-SMF 306-1 instructs the H-RAN 20-1 to configure measurement of a cell supporting the fourth S-NSSAI of the visitor network (step S1006).

For example, the instruction for the H-RAN 20-1 may be made via the RAT/ frequency selection priority (RFSP) index corresponding to the complementary network slice (fourth S-NSSAI) of the visitor network.

Here, it is considered that the RFSP corresponding to the complementary network slice of the visitor network selects a candidate of a carrier frequency supporting the network slice of the visitor network as a secondary node (SN) of the dual connectivity.

The H-AMF 301-1 may acquire a first RESP index and a second RFSP index according to an instruction from the H-SMF 306-1.

The first RESP index is an index for selecting a candidate of a carrier frequency supporting the network slice (third S-NSSAI) of the home network as a master node (MN) of the dual connectivity.

The second RFSP index is an index for selecting a candidate of the carrier frequency supporting the network slice of the visitor network as the SN of the dual connectivity.

Alternatively, the H-AMF 301-1 may acquire one RFSP index in consideration of the dual connectivity with the visitor network.

The H-RAN 20-1 configures, in the UE 10, measurement of a cell supporting the fourth S-NSSAI of the visitor network (step S1007). For example, the H-RAN 20-1 performs, by using an RRCReconfiguration message, configuration necessary for measurement for specifying a cell supporting the fourth S-NSSAI of the visitor network as the SN of the dual connectivity and reporting of a measurement result.

Here, in a case where there are a plurality of candidates of the visitor network, the H-RAN 20-1 may configure a relative priority of the visitor network in the UE 10. Furthermore, in a case where there are a plurality of carrier frequency candidates for the fourth S-NSSAI, the H-RAN 20-1 may configure a relative priority of the carrier frequency in the UE 10.

The UE 10 starts measurement from the visitor network with a higher priority. In addition, the UE 10 sequentially performs measurement for each visitor network from the carrier frequency with a higher priority. Then, in a case where a condition for reporting the measurement result is satisfied, the UE 10 transmits the measurement result to the H-RAN 20-1.

The H-RAN 20-1 specifies the V-RAN 20-2 as a cell supporting the fourth S-NSSAI based on the result of measuring the cell of the visitor network received from the UE 10, and determines to add the specified cell (V-RAN 20-2) as the SN (step S1008).

The H-RAN 20-1 designates a cell to be added as the SN, and instructs the UE 10 to perform processing of adding the cell of the dual connectivity by using an RRCConnectionReconfiguration message (step S1009).

The UE 10 receives the RRCConnectionReconfiguration message. The UE 10 performs a random access procedure on the designated cell (V-RAN 20-2) according to an instruction to add the cell of the dual connectivity (step S1010). The UE 10 establishes connection by the dual connectivity in which the H-RAN 20-1 is the MN and the V-RAN 20-2 is the SN, and ends the processing.

The communication system can perform session update according to the above processing to establish a session based on the architecture illustrated in FIG. 17 or FIG. 18.

The UE 10 transmits or receives the QoS flow to which a 5QI (a 5QI other than the first 5QI) supported by the third S-NSSAI is allocated via the H-RAN 20-1 that is the MN. The UE 10 transmits or receives the QoS flow to which the first 5QI is allocated via the V-RAN 20-2 which is the SN.

Although an example in which the H-SMF 306-1 designates the first 5QI and requests the H-NSSF 304-1 to complement the third S-NSSAI with the visitor network in step S1004 has been described above, the present technology is not limited to this example.

For example, in step S1002, when the H-SMF 306-1 specifies the unsupportable first 5QI among two or more 5QIs supporting the third S-NSSAI, the H-NSSF 304-1 may be notified that the third S-NSSAI cannot be supported.

In this case, the H-NSSF 304-1 specifies the complementary fourth S-NSSAI of the visitor network. If the H-AMF 301-1 is registered (subscribed) to an Nnssf_NSSAIAvailability_Update service, the H-NSSF 304-1 provides information related to the specified fourth S-NSSAI of the visitor network to the H-AMF 301-1. The information related to the specified fourth S-NSSAI of the visitor network is provided as the alternative S-NSSAI and assistance/supplementary information therefor.

The Nnssf_NSSAIAvailability_Update service is a service provided by the H-NSSF 304-1. The H-NSSF 304-1 provides, to the H-AMF 301-1, the information related to the specified fourth S-NSSAI of the visitor network by using a notification of the Nnssf_NSSAIAvailability_Update service.

That is, the H-NSSF 304-1 transmits information and a notification necessary for complementing the third S-NSSAI of the home network with the fourth S-NSSAI of the visitor network to the H-AMF 301-1.

The 5QI described in the above-described embodiments is an example of an index for identifying QoS flows having different characteristics, and is not limited to the fifth generation mobile communication system. That is, the 5QI can be applied to an equivalent index prior to the fourth generation mobile communication system or after the sixth generation mobile communication system.

### 6. Other Embodiments

The above-described embodiments show only examples, and various modifications and applications are possible.

A control device that controls the terminal device 10, the base station 20, or the information processing device 300 of each embodiment may be implemented by a dedicated computer system or may be implemented by a general-purpose computer system.

For example, a communication program for performing the above-described operations is stored in a computer-readable recording medium such as an optical disk, a semiconductor memory, a magnetic tape, or a flexible disk, and distributed. Then, for example, the control device is implemented by installing the program in a computer and performing the above-described processing. At this time, the control device may be a device (for example, a personal computer) outside the terminal device 10, the base station 20, or the information processing device 300. Furthermore, the control device may be a device (for example, the control unit 15, the control unit 24, or the control unit 33) inside the terminal device 10, the base station 20, or the information processing device 300.

Further, the communication program may be stored in a disk device included in a server device on a network such as the Internet, and be downloaded to a computer. Further, the functions described above may be implemented by cooperation between an operating system (OS) and application software. In this case, the part other than the OS may be stored in a medium and distributed, or the part other than the OS may be stored in the server device and downloaded to a computer.

Further, among the processing described in the above-described embodiment, all or some of the processing described as being automatically performed can be manually performed. Alternatively, all or some of the processing described as being manually performed can be automatically performed by a known method. In addition, the processing procedures, specific names, information including various data and parameters illustrated in the specification and drawings can be arbitrarily changed unless otherwise specified. For example, various information illustrated in each drawing is not limited to the illustrated information.

Further, each illustrated component of each device is functionally conceptual, and does not necessarily have to be configured physically as illustrated in the drawings. That is, the specific modes of distribution/integration of the respective devices are not limited to those illustrated in the drawings. All or some of the devices can be functionally or physically distributed/integrated in any arbitrary unit, depending on various loads or the status of use. Note that this configuration by distribution and integration may be dynamically made.

Further, the above-described embodiments can be appropriately combined as long as the processing contents do not contradict each other. Further, the order of the steps illustrated in the sequence diagram and the like of the above-described embodiments can be changed as appropriate.

Furthermore, for example, the present embodiment can be implemented as any component included in the device or system, for example, a processor as a system large scale integration (LSI) or the like, a module using a plurality of processors or the like, a unit using a plurality of modules or the like, a set obtained by further adding other functions to a unit, or the like (that is, some components of the device).

Note that, in the present embodiment, the system means a set of a plurality of components (devices, modules (parts), and the like), and it does not matter whether or not all the components are in the same housing. Therefore, a plurality of devices housed in separate housings and connected via a network and one device in which a plurality of modules are housed in one housing are both systems.

Furthermore, for example, the present embodiment can adopt a configuration of cloud computing in which one function is shared and processed by a plurality of devices in cooperation via a network.

### 7. Conclusion

Although the respective embodiments of the present disclosure have been described above, the technical scope of the present disclosure is not limited to the above-described embodiments, and various modifications can be made without departing from the scope of the present disclosure. Moreover, components of different embodiments and modified examples may be appropriately combined.

Further, the effects in each embodiment described in the present specification are merely examples. The effects of the present disclosure are not limited thereto, and other effects may be obtained.

Note that the present technology can also have the following configurations.

(1)

An information processing device comprising:
a control unit that acquires, from a home network, first quality information regarding one or more first communication qualities supported by a requestable slice whose use is requestable by a terminal device among first network slices provided by the home network, selects a support slice that supports a second communication quality corresponding to the first quality information among second network slices provided by a visitor network, generates mapping information regarding a correspondence between a configured slice configured by the visitor network and including the selected support slice, and the requestable slice, and notifies the terminal device of configured slice information regarding the configured slice and the mapping information.
   (2)

The information processing device according to (1), wherein the control unit notifies of the configured slice information and the mapping information in response to a request from the terminal device.

(3)

The information processing device according to (1) or (2), wherein the control unit selects two or more support slices to support two or more first communication qualities, and generates the mapping information related to a correspondence between a set of the two or more support slices and the requestable slice.

(4)

The information processing device according to any one of (1) to (3), wherein the control unit instructs the terminal device to perform registration processing or re-registration processing in the visitor network according to the configured slice information regarding the configured slice.

(5)

The information processing device according to any one of (1) to (4), wherein the control unit receives, from the terminal device, requested slice information regarding a requested slice whose use is requested by the terminal device among the second network slices, and request mapping information regarding a correspondence between the requested slice and the requestable slice, selects an allowed slice allowed to be used by the terminal device residing in the visitor network among the requested slices, and generates allowed slice information regarding the allowed slice.

(6)

The information processing device according to (5), wherein the control unit configures, as a rejected slice, the support slice that is not allowed to be used by the terminal device in a registration area for the terminal device of the visitor network.

(7)

The information processing device according to (5) or (6), wherein the control unit assigns a data network name (DNN) to be used to the allowed slice.

(8)

The information processing device according to any one of (1) to (7), wherein the control unit acquires, in a case where the first network slice is a network slice that supports a time sensitive communication (TSC) quality-of-service (QoS) flow, parameter information related to a QoS parameter for supporting QoS control corresponding to the requestable slice from the home network, and selects a support slice that supports the QoS parameter from among the second network slices provided by the visitor network.

(9)

A terminal device comprising:
a control unit that acquires, from an information processing device, configured slice information, which is a second network slice provided by a visitor network in which the terminal device resides, and is configured by the visitor network, and mapping information, wherein
   the configured slice information includes information regarding a support slice that supports a second communication quality corresponding to a first quality information among the second network slices,
the first quality information includes information regarding one or more first communication qualities supported by a requestable slice whose use in a home network is requestable by the control unit among first network slices provided by the home network, and
   the mapping information includes information regarding a correspondence between the requestable slice and the support slice.
   (10)

The terminal device according to (9), wherein the control unit requests for at least one of update and acquisition of the configured slice information via a base station of the visitor network prior to a request for registration in the visitor network in a case where the terminal device does not have the configured slice information.

(11)

The terminal device according to (9) or (10), wherein the control unit selects at least one requested slice among the requestable slices, specifies the support slice corresponding to the selected requested slice among the support slices included in the configured slice information, generates requested slice information including information regarding the specified support slice, generates request mapping information regarding a correspondence between the support slice included in the requested slice information and the selected requested slice, and transmits, to a base station of the visitor network, a request for registration in the visitor network, the request including the requested slice information and the request mapping information.

(12)

The terminal device according to (10), wherein the control unit receives, as a response to the request for registration, registration acceptance including allowed slice information regarding an allowed slice whose use by the terminal device is allowed among the support slices and DNN information regarding a DNN assigned to the allowed slice.

(13)

The terminal device according to (12), wherein the control unit transmits, to the base station of the visitor network, a session establishment request including allowed slice identification information for identifying one or more allowed slices and the DNN assigned to the one or more allowed slices.

(14)

The terminal device according to (13), wherein in a case where different DNNs are assigned to two or more allowed slices, the control unit transmits, to the base station, a first session establishment request including one of the allowed slices and the corresponding DNN and a second session establishment request including the other one of the allowed slices and the corresponding DNN.

(15)

The terminal device according to (14), wherein in a case where one DNN is assigned to two or more allowed slices, the control unit transmits, to the base station, the session establishment request including two or more allowed slices, one corresponding DNN, and an instruction to process the two or more allowed slices in one session by the one DNN.

(16)

The terminal device according to (9), wherein

the control unit transmits a registration request including requested slice information, complementary mapping information, and a complementation request to a home network side information processing device,
the requested slice information is information regarding a requested slice whose use is requested by the control unit among the first network slices provided by the home network,
the complementary mapping information is information regarding a correspondence between the requested slice and the support slice that supports the second communication quality corresponding to one or more first communication qualities supportable by the requested slice among the second network slices provided by the visitor network,
the complementation request requests for complementation of the requested slice with the support slice, and
   the home network side information processing device acquires, when the registration request is received, requestable slice information regarding a requestable slice whose use is requestable by the terminal device among the first network slices from the home network, and configures the requested slice as a conditional allowed slice in a case where the support slice is configured to support a third communication quality corresponding to the first communication quality that is not supported by the requested slice.
   (17)

An information processing method comprising:
acquiring, from a home network, first quality information regarding one or more first communication qualities supported by a requestable slice whose use is requestable by a terminal device among first network slices provided by the home network;
selecting a support slice that supports a second communication quality corresponding to the first quality information among second network slices provided by a visitor network;
generating mapping information regarding a correspondence between a configured slice configured by the visitor network and including the selected support slice, and the requestable slice; and
notifying the terminal device of configured slice information regarding the configured slice and the mapping information.
   (18)

A base station comprising:
a control unit that receives mapping information, support slice information, and priority information from a terminal device, wherein
the mapping information is information regarding a correspondence between an allowed slice whose use by the terminal device is allowed among first network slices provided by a home network and a support slice that supports a second communication quality corresponding to a first communication quality supported by the allowed slice among second network slices provided by a visitor network,
the support slice information is information regarding the support slice,
the priority information is information regarding a priority for frequency selection for the support slice, and
the control unit configures a parameter related to cell reselection for redirecting to a cell providing the support slice in the terminal device according to the priority information.
   (19)

The base station according to (18), wherein the control unit receives, from an information processing device, a registration accept message including the mapping information and partially allowed slice information regarding a partially allowed slice including the support slice, and transmits the registration accept message to the terminal device.

(20)

An information processing device including:
a control unit that receives a registration request including requested slice information, mapping information, and a complementation request from a terminal device, in which
the requested slice information is information regarding a requested slice whose use is requested by the terminal device among the first network slices provided by the home network,
the mapping information is information regarding a correspondence between the requested slice and the support slice that supports the second communication quality corresponding to one or more first communication qualities supportable by the requested slice among the second network slices provided by the visitor network,
the complementation request requests for complementation of the requested slice with the support slice, and
   the control unit acquires, when the registration request is received, requestable slice information regarding a requestable slice whose use is requestable by the terminal device among the first network slices from the home network, and configures the requested slice as a conditional allowed slice in a case where the support slice is configured to support a third communication quality corresponding to the first communication quality that is not supported by the requested slice.
   (21)

The information processing device according to (20), in which the control unit returns a response including information regarding the conditional allowed slice to the terminal device.

(22)

The information processing device according to (20) or (21), in which the control unit configures the requested slice as a rejected slice in a case where the support slice is not configured to support the third communication quality.

(23)

The information processing device according to (20), in which the control unit receives, from the terminal device, a session establishment request including the requested slice information regarding the requested slice, the mapping information regarding the correspondence between the requested slice and the support slice, and the complementation request, establishes a first session for the requested slice in a case where the terminal device resides in a service area of the support slice that supports the third communication quality, and instructs the terminal device to establish dual connectivity for the first session, the dual connectivity including first connection to a home base station that belongs to the home network and second connection to a visitor base station that belongs to the visitor network.

(24)

The information processing device according to (23), in which the control unit transmits or receives, via the first connection, a first QoS flow corresponding to the first communication quality supported by the requested slice, and transmits or receives, via the second connection, a second QoS flow corresponding to the third communication quality supported by the support slice.

(25)

The information processing device according to (23) or (24), in which the control unit causes the visitor network to select a user plane function that supports a function of an uplink classifier or a branching point, and connects the second connection to third connection to an edge application server via the user plane function.

(26)

The information processing device according to (25), in which
the first session is associated with one DNN, and
the home network manages, for the one DNN, one or more data network access identifiers including a data network access identifier that identifies the third connection.
   (27)

A terminal device including:
a control unit that transmits a registration request including requested slice information, mapping information, and a complementation request to an information processing device, in which
the requested slice information is information regarding a requested slice whose use is requested by the control unit among the first network slices provided by the home network,
the mapping information is information regarding a correspondence between the requested slice and the support slice that supports the second communication quality corresponding to one or more first communication qualities supportable by the requested slice among the second network slices provided by the visitor network,
the complementation request requests for complementation of the requested slice with the support slice, and
   the information processing device acquires, when the registration request is received, requestable slice information regarding a requestable slice whose use is requestable by the control unit among the first network slices from the home network, and configures the requested slice as a conditional allowed slice in a case where the support slice is configured to support a third communication quality corresponding to the first communication quality that is not supported by the requested slice.
   (28)

The terminal device according to (27), in which the control unit acquires information regarding the conditional allowed slice and information regarding a condition of the conditional allowed slice from the information processing device.

(29)

The terminal device according to (28), in which in a case where the condition is that the requested slice is complemented with the support slice that supports the third communication quality in a service area of the support slice that supports the third communication quality, and the terminal device itself is within the service area, the control unit transmits, to a home base station belonging to the home network, a session establishment request including the requested slice information regarding the requested slice, the mapping information regarding a correspondence between the requested slice and the support slice that supports the third communication quality, and the complementation request.

(30)

The terminal device according to any one of (27) to (29), in which the control unit establishes a first session for the requested slice in a case of residing in the service area of the support slice that supports the third communication quality, and establishes, for the first session, dual connectivity including first connection to the home base station that belongs to the home network and second connection to a visitor base station that belongs to the visitor network.

(31)

The terminal device according to (30), in which the control unit transmits or receives, via the first connection, a first QoS flow corresponding to the first communication quality supported by the requested slice, and transmits or receives, via the second connection, a second QoS flow corresponding to the third communication quality supported by the support slice.

(32)

An information processing method including:
receiving a registration request including requested slice information, mapping information, and a complementation request from a terminal device, the requested slice information being information regarding a requested slice whose use is requested by the terminal device among the first network slices provided by the home network, the mapping information being information regarding a correspondence between the requested slice and the support slice that supports the second communication quality corresponding to one or more first communication qualities supportable by the requested slice among the second network slices provided by the visitor network, and the complementation request requesting for complementation of the requested slice with the support slice;
acquiring, when the registration request is received, requestable slice information regarding a requestable slice whose use is requestable by the terminal device among the first network slices from the home network; and
configuring the requested slice as a conditional allowed slice in a case where the support slice is configured to support a third communication quality corresponding to the first communication quality that is not supported by the requested slice.
   (33)

A base station including:
a control unit that receives a session establishment request including requested slice information, mapping information, and a complementation request from a terminal device, in which
the requested slice information is information regarding a requested slice whose use is requested by the terminal device among the first network slices provided by the home network,
the mapping information is information regarding a correspondence between the requested slice and the support slice that supports a second communication quality corresponding to a first communication quality that is not supported by the requested slice among second network slices provided by a visitor network,
the complementation request requests for complementation of the requested slice with the support slice, and
   the control unit establishes first connection to a home base station that belongs to the home network for a first session established in a case where the terminal device resides within a service area of the support slice that supports the second communication quality, and requests the terminal device to establish second connection to a visitor base station that belongs to the visitor network.
   (34)

The base station according to (33), in which the control unit notifies the terminal device of an identifier that identifies the first session and a first session update request for adding a session via the visitor network including the second connection to the first session.

(35)

A visitor base station that belongs to a visitor network, the visitor base station including:
a control unit that receives an establishment request for establishing second connection from a terminal device that has established first connection with a home base station that belongs to a home network, in which
the terminal device transmits a session establishment request including requested slice information, mapping information, and a complementation request to the home base station,
the requested slice information is information regarding a requested slice whose use is requested by the terminal device among the first network slices provided by the home network,
the mapping information is information regarding a correspondence between the requested slice and the support slice that supports a second communication quality corresponding to a first communication quality that is not supported by the requested slice among second network slices provided by a visitor network,
the complementation request requests for complementation of the requested slice with the support slice, and
the terminal device establishes the first connection with the home base station that belongs to the home network for a first session established in a case where the terminal device resides within a service area of the support slice that supports the second communication quality.
   (36)

The base station according to (35), in which the control unit receives a first session update instruction to add a session via the visitor network including the second connection from a home information processing device of the home network.

(37)

The base station according to (36), in which the first session update instruction includes an identifier that identifies the first session.

(38)

The base station according to (36) or (37), in which the control unit acquires, in a case where a resource type of a QoS flow transmitted or received via the second connection is a delay-critical GBR, a data network access identifier that identifies connection to an edge application server from a visitor information processing device of the visitor network, and performs mapping of the second connection and third connection corresponding to the data network access identifier.

(39)

An information processing device including:
a control unit that receives, from a terminal device, a session establishment request including requested slice information regarding a requested slice whose use is requested by the terminal device among first network slices provided by a home network, establishes a first session for the requested slice with the terminal device, specifies, in the first session, an unsupportable first QoS flow among two or more QoS flows required for the requested slice, specifies, among configurable slices that are configurable and are second network slices provided by a visitor network, a support slice that supports a second QoS flow corresponding to the first QoS flow, and determines to complement the first session with the support slice.
   (40)

The information processing device according to (39), in which the control unit instructs a base station to which the terminal device is connected to configure measurement of a cell supporting the support slice.

(41)

A base station including:
a control unit that receives, from a terminal device, a session establishment request including requested slice information regarding a requested slice whose use is requested by the terminal device among first network slices provided by a home network, establishes a radio bearer with the terminal device that belongs to a first session for the requested slice, and configures, in the terminal device, measurement of a cell supporting a support slice that is a second network slice provided by a visitor network and supports a second QoS flow corresponding to an unsupportable first QoS flow among two or more QoS flows required for the requested slice.
   (42)

The base station according to (41), in which the control unit acquires a result of the measurement of the cell from the terminal device.

(43)

The base station according to (41) or (42), in which the control unit instructs the terminal device to change a connection configuration for dual connectivity according to a result of the measurement of the cell.

(44)

The base station according to any one of (41) to (43), in which the control unit receives information regarding a QoS flow other than the first QoS flow among two or more QoS flows required for the requested slice from the terminal device or transmits the information to the terminal device.

### REFERENCE SIGNS LIST

10 Terminal device
11, 21, 31 Communication unit
12, 22, 32 Storage unit
13, 23 Network communication unit
14 Input/output unit
15, 24, 33 Control unit
20 Base station
111, 211 Reception processing unit
112, 212 Transmission processing unit
113, 213, 214 Antenna
211a Wireless reception unit
211b Demultiplexing unit
211c Demodulation unit
211d Decoding unit
212a Coding unit
212b Modulation unit
212c Multiplexing unit
212d Wireless transmission unit
300 Information processing device

1. An information processing device comprising:
circuitry configured to
acquire, from a home network, first quality information regarding one or more first communication qualities supported by a requestable slice, the requestable slice being a slice that is requestable by a terminal device,
select a support slice that supports a second communication quality corresponding to the first quality information, the support slice being a slice provided by a visitor network, and
generate mapping information regarding a correspondence between a configured slice that is configured by the visitor network and including the selected support slice, and the requestable slice, and
notify the terminal device of configured slice information regarding the configured slice and the mapping information for use in wireless communication by the terminal device.

2. The information processing device according to claim 1, wherein the requestable slice is a slice among one or more first network slices, and the support slice is a slice among one or more second network slices.

3. The information processing device according to claim 2, wherein, in response to a request from the terminal device, the circuitry is configured provide notification of the configured slice information and the mapping information.

4. The information processing device according to claim 2, wherein the support slice is a slice among two or more second slices, and the circuitry is further configured to
select two or more support slices to support two or more first communication qualities, and
generate the mapping information related to a correspondence between a set of the two or more support slices and the requestable slice.

5. The information processing device according to claim 2, wherein the circuitry is configured to instruct the terminal device to register or re-register in the visitor network according to the configured slice information regarding the configured slice.

6. The information processing device according to claim 2, wherein the circuitry is further configured to
receive from the terminal device requested slice information regarding a requested slice that is requested from the terminal device among the one or more second network slices,
request mapping information regarding a correspondence between the requested slice and the requestable slice,
select an allowed slice allowed for use by the terminal device, and
generate allowed slice information regarding the allowed slice.

7. The information processing device according to claim 6, wherein the circuitry is configured to set, as a rejected slice, a support slice that is not allowed to be used by the terminal device in a registration area for the terminal device of the visitor network.

8. The information processing device according to claim 6, wherein the circuitry is configured to assign a data network name (DNN) to the allowed slice.

9. The information processing device according to claim 2, wherein the circuitry is configured to
acquire, in a case where the requestable is a network slice that supports a time sensitive communication (TSC) quality-of-service (QoS) flow, parameter information related to a QoS parameter for supporting QoS control corresponding to the requestable slice from the home network, and
select, as the support slice, a slice of the one or more second network slices that supports the QoS parameter.

10. A terminal device comprising:
circuitry configured to acquire, from an information processing device, configured slice information, which is a second network slice provided by, and configured by, a visitor network in which the terminal device resides, and mapping information to support wireless communication by the terminal device, wherein
the configured slice information includes information regarding a support slice that supports a second communication quality corresponding to a first quality information,
the first quality information includes information regarding one or more first communication qualities supported by a requestable slice, the requestable slice being a slice that is requestable by the circuitry, and
the mapping information includes information regarding a correspondence between the requestable slice and the support slice.

11. The terminal device according to claim 10, wherein the circuitry is configured to request for at least one of update and acquisition of the configured slice information via a base station of the visitor network prior to a request for registration in the visitor network in a case where the terminal device does not have the configured slice information.

12. The terminal device according to claim 10, wherein the circuitry is configured to
select at least one requested slice among a plurality of requestable slices,
specify the support slice corresponding to the at least one requested slice among a plurality of support slices included in the configured slice information,
generate requested slice information including information regarding the specified support slice,
generate request mapping information regarding a correspondence between the support slice included in the requested slice information and the selected requested slice, and
transmit, to a base station of the visitor network, a request for registration in the visitor network, the request including the requested slice information and the requested mapping information.

13. The terminal device according to claim 11, wherein the circuitry is further configured to
receive, as a response to the request for registration, registration acceptance including allowed slice information regarding an allowed slice for the terminal device and DNN information regarding a DNN assigned to the allowed slice.

14. The terminal device according to claim 13, wherein the circuitry is configured to
transmit, to the base station, a session establishment request including allowed slice identification information that identifies one or more allowed slices and the DNN assigned to the one or more allowed slices.

15. The terminal device according to claim 14, wherein the circuitry is configured to transmit, in a case where different DNNs are assigned to two or more allowed slices, to the base station, a first session establishment request including one of the allowed slices and the corresponding DNN and a second session establishment request including the other one of the allowed slices and the corresponding DNN, and
in a case where one DNN is assigned to two or more allowed slices, to the base station, the session establishment request including two or more allowed slices, one corresponding DNN, and an instruction to process the two or more allowed slices in one session by the one DNN.

16. The information processing device according to claim 2, wherein the support slice is a second S-NSSAI supporting a 5QI corresponding to a 5QI of the requestable slice that is a first S-NSSAI.

17. The information processing device according to claim 16, wherein the circuitry is further configured to
add the second S-NSSAI is added to the configured slice, and
generate mapping information of the second S-NSSAI with respect to the first S-NSSAI.

18. An information processing method comprising:
acquiring, from a home network, first quality information regarding one or more first communication qualities supported by a requestable slice, the requestable slice being a slice that is requestable by a terminal device;
selecting a support slice that supports a second communication quality corresponding to the first quality information, the support slice being a slice provided by a visitor network;
generating mapping information regarding a correspondence between a configured slice configured by the visitor network and including the selected support slice, and the requestable slice; and
notifying the terminal device of configured slice information regarding the configured slice and the mapping information for use in wireless communications by the terminal device.

19. A base station comprising:
circuitry configured to
receive mapping information, support slice information, and priority information from a terminal device, wherein
the mapping information is information regarding a correspondence between an allowed slice that is allowed to be used by the terminal device and a support slice that supports a second communication quality corresponding to a first communication quality supported by the allowed slice,
the support slice information is information regarding the support slice,
the priority information is information regarding a priority for frequency selection for the support slice, and
the circuitry is configured to set a parameter related to cell reselection to redirect to a cell providing the support slice in the terminal device according to the priority information.

20. The base station according to claim 19, wherein the circuitry is configured to receive, from an information processing device, a registration accept message including the mapping information and partially allowed slice information regarding a partially allowed slice including the support slice, and transmit the registration accept message to the terminal device.
